(19) United States
(12) Patent Application Publication
(10) Pub. No.: US 2025/0358822 A1
(43) Pub. Date: Nov. 20, 2025

(54) CONFIGURING RESOURCES FOR UPLINK TRANSMISSIONS

(71) Applicant: ZTE Corporation, Shenzhen (CN)

(72) Inventors: Wei GOU, Shenzhen (CN); Xianghui HAN, Shenzhen (CN); Shuaihua KOU, Shenzhen (CN); Xingguang WEI, Shenzhen (CN)

(73) Assignee: ZTE Corporation, Shenzhen (CN)

(21) Appl. No.: 19/286,891

(22) Filed: Jul. 31, 2025

Related U.S. Application Data
(63) Continuation of application No. PCT/CN2023/076859, filed on Feb. 17, 2023.

(51) Int. Cl. H04W 72/21; H04L 5/00; H04L 27/26

(52) U.S. Cl. CPC H04W 72/21; H04L 5/0044; H04L 27/2678

(57) ABSTRACT

Presented are systems, methods, apparatuses, or computer-readable media for configuring resources for uplink (UL) transmissions. A wireless communication device may receive, from a wireless communication node, a configuration of resources for uplink (UL) transmission. The wireless communication device may determine at least one resource for an UL subband of the wireless communication device.

### CROSS-REFERENCE TO RELATED APPLICATION

This application claims the benefit of priority under 35 U.S.C. § 120 as a continuation of International Patent Application No. PCT/CN2023/076859, filed on Feb. 17, 2023, the disclosure of which is incorporated herein by reference in its entirety.

### TECHNICAL FIELD

The disclosure relates generally to wireless communications, including but not limited to systems and methods for configuring resources for uplink (UL) transmissions.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for configuring resources for uplink (UL) transmissions. A wireless communication device may receive, from a wireless communication node, a configuration of resources for uplink (UL) transmission. The wireless communication device may determine at least one resource for an UL subband of the wireless communication device.

In some embodiments, resources of a cell-specific UL subband may be configured by the configuration, and wherein (i) a resource set C may refer to a candidate resource set, and (ii) symbol attribute parameters may refer to at least one of a subcarrier spacing or a cyclic prefix. In some embodiments, when the UL transmission is scheduled or configured in resources of the cell-specific UL subband for the wireless communication device, if a resource set C of the cell-specific UL subband is not configured, the wireless communication device may determine with the wireless communication node that the cell-specific UL subband uses a resource set C of an UL bandwidth part (BWP) or an initial BWP of the wireless communication device. In some embodiments, if symbol attribute parameters of the cell-specific UL subband are not configured, the wireless communication device may determine with the wireless communication node that the cell-specific UL subband uses symbol attribute parameters of the UL BWP or the initial BWP of the wireless communication device.

In some embodiments, when at least one of: a resource set C or symbol attribute parameters of the cell-specific UL subband are configured, and if the UL transmission is scheduled or configured in resources of the cell-specific UL subband for the wireless communication device, then the wireless communication device may determine with the wireless communication node that: the UL transmission is executed based on at least one of symbol attribute parameters or a resource set C: (a) of an UL bandwidth part (BWP) of the wireless communication device; or (b) indicated by signaling of the wireless communication node.

In some embodiments, when the cell-specific UL subband is configured in a downlink (DL) symbol or slot, and if the UL transmission is scheduled or configured in resources of the cell-specific UL subband for the wireless communication device, the UL transmission may be executed based on symbol attribute parameters of a DL bandwidth part (BWP) of the wireless communication device or based on the symbol attribute parameters of an UL BWP of the wireless communication device.

In some embodiments, when the cell-specific UL subband is configured in a flexible symbol or slot, and if the UL transmission is scheduled or configured in resources of the cell-specific UL subband for the wireless communication device, the UL transmission may be executed based on the symbol attribute parameters of an UL bandwidth part (BWP) of the wireless communication device or the UL transmission is executed based on symbol attribute parameters of a DL BWP of the wireless communication device.

In some embodiments, when the cell-specific UL subband is configured in a DL symbol or slot converted from a flexible symbol or slot, and if the UL transmission is scheduled or configured in resources of the cell-specific UL subband for the wireless communication device, then the UL transmission may be executed based on symbol attribute parameters of a DL bandwidth part (BWP) of the wireless communication device or the UL transmission is executed based on symbol attribute parameters of an UL BWP of the wireless communication device.

In some embodiments, resources of a UE-specific UL subband may be configured by the configuration, and wherein (i) a resource set C may refer to a candidate resource set, and (ii) symbol attribute parameters may refer to at least one of a subcarrier spacing or a cyclic prefix. In some embodiments, when the UL transmission is scheduled or configured in resources of the UE-specific UL subband for the wireless communication device, if a resource set C of the UE-specific UL subband is not configured, the wireless communication device may determine with the wireless communication node that the UE-specific UL subband uses a resource set C of an UL bandwidth part (BWP) or an initial BWP of the wireless communication device. In some embodiments, if symbol attribute parameters of the UE-specific UL subband are not configured, the wireless communication device may determine with the wireless communication node that the UE-specific UL subband uses symbol attribute parameters of the UL BWP or the initial BWP of the wireless communication device.

In some embodiments, when at least one of: a resource set C or symbol attribute parameters of the UE-specific UL subband are configured, and if the UL transmission is scheduled or configured in resources of the UE-specific UL subband for the wireless communication device, then the wireless communication device may determine with the wireless communication node that: the UL transmission may be executed based on at least one of symbol attribute parameters or a resource set C: (a) of an UL bandwidth part (BWP) of the wireless communication device; or (b) indicated by signaling of the wireless communication node.

In some embodiments, when the UE-specific UL subband is configured in a DL symbol or slot, and if the UL transmission is scheduled or configured in resources of the UE-specific UL subband for the wireless communication device, the UL transmission may be executed based on symbol attribute parameters of a DL bandwidth part (BWP) of the wireless communication device or the UL transmission is executed based on symbol attribute parameters of an UL BWP of the wireless communication device.

In some embodiments, when the UE-specific UL subband is configured in a flexible symbol or slot, and if the UL transmission is scheduled or configured in resources of the UE-specific UL subband for the wireless communication device, the UL transmission may be executed based on symbol attribute parameters of an UL bandwidth part (BWP) of the wireless communication device or the UL transmission is executed based on symbol attribute parameters of a DL BWP of the wireless communication device.

In some embodiments, when the UE-specific UL subband is configured in a DL symbol or slot converted from the flexible symbol or slot, and if the UL transmission is scheduled or configured in resources of the UE-specific UL subband for the wireless communication device, then the UL transmission may be executed based on symbol attribute parameters of a DL bandwidth part (BWP) of the wireless communication device or the UL transmission is executed based on symbol attribute parameters of an UL BWP of the wireless communication device.

In some embodiments, resources of a cell-specific UL subband may be configured by the configuration, resources of a UE-specific UL subband may be also configured by the configuration, and (i) a resource set C may refer to a candidate resource set, and (ii) symbol attribute parameters may refer to at least one of a subcarrier spacing or a cyclic prefix.

In some embodiments, when the UL transmission is scheduled or configured in resources of the cell-specific UL subband for the wireless communication device, the wireless communication device may determine with the wireless communication node that the cell-specific UL subband uses a resource set C of the UE-specific UL subband of the wireless communication device, or the cell-specific UL subband may use a resource set C of an UL bandwidth part (BWP) or an initial BWP of the wireless communication device if a resource set C of the UE-specific UL subband is not configured. In some embodiments, the wireless communication device may determine with the wireless communication node that the cell-specific UL subband uses symbol attribute parameters of the UE-specific UL subband of the wireless communication device; or the cell-specific UL subband may use symbol attribute parameters of an UL bandwidth part (BWP) or an initial BWP of the wireless communication device if symbol attribute parameters of the UE-specific UL subband is not configured.

In some embodiments, when at least one of: a resource set C or symbol attribute parameters of the cell-specific UL subband are configured, and at least one of: a resource set C or symbol attribute parameters of the UE-specific UL subband are configured, and if the UL transmission is scheduled or configured in resources of the UL subband for the wireless communication device, then the wireless communication device may determine with the wireless communication node that: the UL transmission may be scheduled or configured in intersection resources of the cell-specific UL subband, the UE-specific UL subband and UL BWP resources of the wireless communication device.

In some embodiments, the UL transmission may be executed based on at least one of symbol attribute parameters or a resource set C of the UE-specific UL subband. In some embodiments, the UL transmission may be executed based on at least one of symbol attribute parameters or a resource set C of a BWP of the wireless communication device. In some embodiments, the wireless communication node may indicate by signaling at least one of symbol attribute parameters or a resource set C used for the UL transmission.

In some embodiments, the wireless communication device may determine a parameter A in an UL grant. In some embodiments, the parameter A may be indicative of: whether a physical uplink shared channel (PUSCH) resource allocation indicator in the UL grant is based on a PUSCH candidate resource set configured for a SBFD slot or on a PUSCH candidate resource set configured for a non-SBFD slot; whether the UL grant itself is based on the PUSCH candidate resource set configured for the SBFD slot or on the PUSCH candidate resource set configured for the non-SBFD slot; or whether the UL grant itself is based on the SBFD slot or based on non-SBFD slot.

In some embodiments, the wireless communication device may determine a parameter B in an UL grant. In some embodiments, the parameter B may be indicative of: whether a physical uplink shared channel (PUSCH) transmission scheduled in the UL grant is based on at least one of a subcarrier spacing or a cyclic prefix of the UL subband, or based on at least one of a subcarrier spacing or a cyclic prefix of an UL bandwidth part (BWP); whether the UL grant itself is based on at least one of the subcarrier spacing or the cyclic prefix of the UL subband, or based on at least one of the subcarrier spacing or the cyclic prefix of the UL BWP; or whether the UL grant itself is based on the UL subband, or based on the UL BWP.

In some embodiments, a first candidate set of PUSCH resources may be configured for slots not configured with UL subband via a first table, and a second candidate set of PUSCH resources may be configured for slots configured with UL subband via a second table. In some embodiments, k2 values may be included in a defined column in each of the first table and the second table. A respective k2 value in each row of the first table may be same as that in a corresponding row of the second table. A k2 value may represent a slot interval between a slot. The UL grant may be located and a slot where a corresponding physical uplink shared channel (PUSCH) transmission scheduled by the UL grant may be located. In some embodiments, each PUSCH resource in the first candidate set may be configured via information in at least one column and a respective row of the first table. In some embodiments, each PUSCH resource in the second candidate set may be configured via information in at least one column and a respective row of the second table.

In some embodiments, two PUSCH candidate resource sets may be configured for slots not configured with UL subband and slots configured with UL subband as the first table and the second table respectively. In some embodiments, the PUSCH resources may be configured as a column of the first table. In some embodiments, the k2 values may be configured as another column of the first table. The PUSCH resources may be configured as a column of the second table, and the k2 values are configured as another column of the second table. Each row of the first table and second table may contain one PUSCH resource and one k2 value respectively. The same row index in the first table and the second table may be configured with a same k2 value. In some embodiments, k2 may represent the slot interval between the slot where the UL grant is located and the slot where the PUSCH scheduled by the UL grant is located.

In some embodiments, a first candidate set of PUSCH resources may be configured for slots not configured with UL subband via a table, and a second candidate set of PUSCH resources may be configured for slots configured with UL subband via the table. In some embodiments, k2 values may be included in a defined column in the table. In some embodiments, a k2 value in each row of the table is associated with the PUSCH resource for slots not configured with UL subband and the PUSCH resource for slots configured with UL subband. In some embodiments, a k2 value may represent a slot interval between a slot where the UL grant is located and a slot where a corresponding physical uplink shared channel (PUSCH) transmission scheduled by the UL grant is located. In some embodiments, each PUSCH resource in the first candidate set may be configured via information in at least one column and a respective row of the table. In some embodiments, each PUSCH resource in the second candidate set may be configured via information in at least one other column and a respective row of the table.

In some embodiments, two PUSCH candidate resource sets may be simultaneously configured for slots not configured with UL subband and slots configured with UL subband in the third table. In some embodiments, the PUSCH resources for slots not configured with UL subband may be configured as a column of the third table, and the PUSCH resources for slots configured with UL subband may be configured as a column of the third table, and the k2 values may be configured as a column of the third table. In some embodiments, each row of the third table may contain one PUSCH resource for slots not configured with UL subband, one PUSCH resource for slots configured with UL subband, and one k2 value. In some embodiments, k2 represents the slot interval between the slot where the UL grant is located and the slot where the PUSCH scheduled by the UL grant is located.

At least one aspect is directed to a system, a method, an apparatus, or a computer-readable medium for configuring resources for uplink (UL) transmissions. A wireless communication node may send, to a wireless communication device, a configuration of resources for uplink (UL) transmission. The wireless communication device may determine at least one resource for an UL subband of the wireless communication device.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure; and

FIG. 3 illustrates a flow diagram of a method of configuring resources for uplink transmissions in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

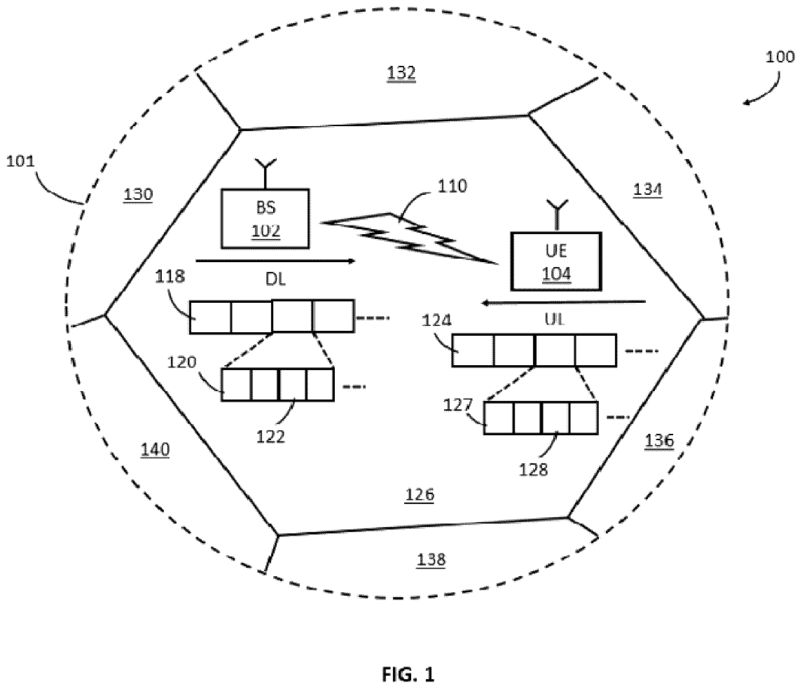

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

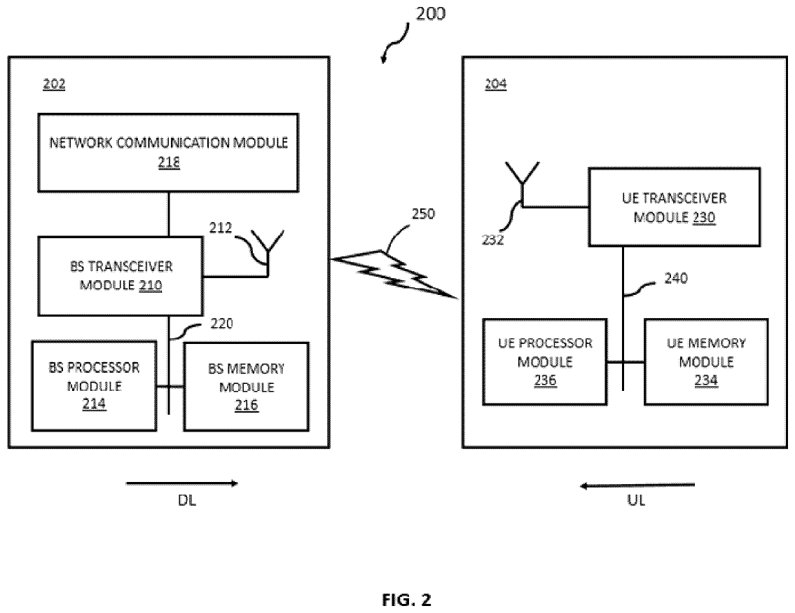

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Configuring Uplink Transmissions

For a time division duplex (TDD) carrier, a downlink (DL) slot and a uplink (UL) slot may be time-divisionally configured. Further, in certain deployed networks, DL slots may be configured more than UL slots. For example, a slot structure may be DDDSU. Here, D may represent a DL slot, U may represent a UL slot, and S may represent a flexible slot, which may contain DL symbols and UL symbols. UL slots may be fewer and discontinuous, and these characteristics may affect the performance of UL transmission. For example, large data volume of UL cannot be supported, but more importantly, the timeliness and edge coverage of UL transmission may be relatively poor (e.g., due to lack of consecutive UL slots).

Therefore, presented herein are techniques for subband full-duplex (SBFD). The UL subband full duplex may be given priority. For example, several consecutive resource blocks (RBs) may be configured as UL subband in the frequency domain, and several DL or flexible orthogonal frequency-division multiplexing OFDM symbols or slots are configured as UL subband in the time domain, so that one UL subband is obtained. That is, a piece of time-frequency resource for UL transmission may be configured in DL symbols or slots, and this time-frequency resource may be a UL subband. Based on the UL subband, a UL transmission can be implemented in a DL symbols or slots. The UL subband can also be configured in flexible symbols.

Presented herein is a UL subband configuration architecture to achieve efficient transmission based on the full duplex mechanism of UL subband. In addition, the present disclosure provides the corresponding UL subband parameter configuration, including how to configure the uplink signal or channel resources and the parameters related to the symbol attributes. Furthermore, the present disclosure provides how determine the UL transmission parameters when different UL subbands are configured with different parameters, and also provides how to determine the UL transmission parameters when the UL subband and UL/DL bandwidth part (BWP) may be configured with different parameters. In this description, the symbol or slot that is configured with UL subband may be referred to as a SBFD symbol or slot, and the symbol or slot that is not configured with UL subband may be referred to as a non-SBFD symbol or slot.

### A. Configuration of Resources of Cell-Specific Uplink (UL) Subband

### I. Configuration Architecture of UL Subband

The base station and UE may agree that only the resources of the cell-specific UL subband may be configured, and the resources of the UE-specific UL subband may not be configured. Table 1 may be referred to for some specific configurations.

TABLE 1
Configuration of cell-specific UL subband

| | | | Subcarrier Spacing |
|---|---|---|---|
| | | Candidate resource | (SCS) and/or cyclic |
| | Resource of | set of channel/signal | prefix (CP) of |
| | cell-specific | of cell-specific | cell-specific |
| Index | UL subband | UL subband | UL subband |
| 0 | 1 | 0 | 0 |
| 1 | 1 | 0 | 1 |
| 2 | 1 | 1 | 0 |
| 3 | 1 | 1 | 1 |

Note:
“1” may indicate that the corresponding item maybe be configured and “0” may indicate that the corresponding item may not be configured.

For the convenience of description below, the candidate resource set of the uplink channel/signal may be referred to as the resource set C, and the Subcarrier Spacing (SCS) and/or cyclic prefix (CP) may be referred to as the symbol attribute parameters.

The resources for a cell-specific UL subband may be configured by the base station based on point-to-multipoint signaling for UEs. That is, all UEs in the cell may receive the same signaling to configure a cell-specific UL subband. From the base station side, only one cell-specific UL subband may be configured in the cell. The resources of cell-specific UL subband may be continuous in frequency domain.

Corresponding to the index 0 in Table 1, only the cell-specific UL subband may be configured with corresponding resources, and the symbol attribute parameters of the cell-specific UL subband may not be configured, and the resource set C corresponding to the cell-specific UL subband may not be configured.

Corresponding to the index 1 in Table 1, the cell-specific UL subband may be configured with corresponding resources, and the symbol attribute parameters of the cell-specific UL subband may also be configured, but the resource set C corresponding to the cell-specific UL subband may not be configured.

Corresponding to the index 2 in Table 1, the cell-specific UL subband may be configured with corresponding resources, and the resource set C corresponding to the cell-specific UL subband may also be configured, but the symbol attribute parameters of the cell-specific UL subband may not be configured/.

Corresponding to the index 3 in Table 1, the cell-specific UL subband may be configured with corresponding resources, the resource set C, and the symbol attribute parameters.

For a UE, the resources of the cell-specific UL subband may intersect with its UL BWP resources at least in the frequency domain, and UL transmission may be scheduled or configured in the intersected resources in the SBFD symbol. The resources of the above cell-specific UL subband may include time-domain resources and/or frequency-domain resources.

The candidate resource set of the uplink channel/signal corresponding to the above cell-specific UL subband may include: a physical uplink shared channel (PUSCH) candidate resource set (including k2, where k2 may be the slot interval between the slot where the UL grant may be located and the slot where the corresponding PUSCH transmission may be located), a physical uplink control channel (PUCCH) resource set (including k1, where k1 may be the slot interval between the slot where a physical downlink shared channel (PDSCH) may be located and the slot where the corresponding hybrid automatic repeat request acknowledgement (HARQ-ACK) PUCCH transmission may be located), a physical random access channel (PRACH) resource or a sounding reference signal (SRS) resource, among others.

The above point-to-multipoint signaling may include: system information block, group physical downlink control channel (PDCCH). The above point-to-point signaling may include PDCCH signaling and UE dedicated radio resource control (RRC) signaling. For example, the PUSCH candidate resource set may be configured based on the signaling PUSCH-Config in accordance with a specification (e.g., in TS38.331), and the PUCCH resource set may be configured based on the signaling PUCCH-Config.

If a UL transmission is scheduled or configured in the resources of the cell-specific UL subband, the UL transmission may be executed based on the symbol attribute parameters of the cell-specific UL subband and the resources selected from the resource set C of the cell-specific UL subband.

However, if the symbol attribute parameters of the cell-specific UL subband are configured, and UL transmissions of different UEs are scheduled or configured in the resources of the cell-specific UL subband, then these UL transmissions may only use the unique symbol attribute parameters of the cell-specific UL subband for all UEs in the cell. It may cause some negative effects. For example, the location and channel quality of different UEs in the cell may be different, so different SCS or CPs for UL transmission may bring higher efficiency from the perspective of different UEs. For example, UE located at the edge of the cell may prefer a longer CP to eliminate interference between adjacent symbols.

Similarly, if the resource set C of the cell-specific UL subband is configured, and UL transmissions of different UEs are scheduled or configured in the resources of the cell-specific UL subband, these UL transmissions may only use the resource set C of the cell-specific UL subband for all UEs in the cell. From the perspective of different UEs, it may lack flexibility in the selection of uplink channel/signal resources.

II. Improvements to Determining the Resource Set C and/or Symbol Attribute Parameters for UL Transmissions Within the Resource of the Cell-Specific UL Subband.

If a UL transmission is scheduled or configured (e.g., by BS to UE) in the resources of the cell-specific UL subband for a UE, and the resource set C of the cell-specific UL subband and the symbol attribute parameters of the cell-specific UL subband are not configured, the base station and the UE may agree that the UL transmission is executed based on the resource set C of the UL BWP of the UE and the symbol attribute parameters of the UL BWP. From the perspective of the UE, if the resource set C of the cell-specific UL subband may not be configured, the base station and the UE may agree that the cell-specific UL subband may use the resource set C of the UL BWP of the UE. If the symbol attribute parameters of the cell-specific UL subband are not configured, the base station and the UE may agree that the cell-specific UL subband may use the symbol attribute parameters of the UL BWP of the UE.

In some embodiments, if the resource set C of the cell-specific UL subband and/or the symbol attribute parameters of the cell-specific UL subband are not configured, the base station and the UE may agree that the UL transmission is executed based on the resource set C of the initial BWP of the UE and/or based on the symbol attribute parameters of the initial BWP of the UE.

### III. Use of Resource Set C and Symbol Attribute Parameters of Cell-Specific UL Subband

In some embodiments, if the resource set C and/or symbol attribute parameters of the cell-specific UL subband are configured, and if a UL transmission is scheduled or configured in the resources of the cell-specific UL subband for a UE, then the base station and the UE may agree that:
the UL transmission is to be executed based on the symbol attribute parameters and/or resource set C of the UL BWP of the UE. This may be a relatively simple method, but it may not be flexible enough.
or, the base station may indicate by signaling the symbol attribute parameters and/or resource set C used for this UL transmission. For example, the signaling may indicate that the symbol attribute parameters or resource set C of the UL BWP may be used for the UL transmission. In another example, the signaling may indicate that the symbol attribute parameters or resource set C of the cell-specific UL subband may be used for the UL transmission. This may be a more efficient method, and this may flexibly change the symbol attribute parameters or resource set C used by UL transmission according to the scheduling requirements. For example, UE located at the cell edge may be more suitable for using longer CP and larger SCS.

In some embodiments, if the resource set C of the cell-specific UL subband and/or the symbol attribute transmission of the cell-specific UL subband are configured, and if a UL transmission related to the initial access is scheduled or configured for a UE in the resource of the cell-specific UL subband, then the UL transmission may be executed based on the symbol attribute parameters and/or resource set C of the cell-specific UL subband. Here, the UL transmission related to the initial access may include the transmission of the initial access sequence, the PUSCH transmission scheduled by a random access response (RAR), and the HARQ-ACK PUCCH transmission in the random access process.

In some embodiments, if the resource set C of the cell-specific UL subband and/or the symbol attribute transmission of the cell-specific UL subband are configured, and if a common UL transmission is scheduled or configured in the resource of the cell-specific UL subband for a UE, then the UL transmission may be executed based on the symbol attribute parameter and/or resource set C of the cell-specific UL subband.

IV. Improvements Based on Symbol Type (DL symbol or F symbol) of the Symbol Where the UL Subband is Located.

In some embodiments, if the symbol attribute parameters of the cell-specific UL subband not configured, and if a UL transmission is scheduled or configured in the resources of the cell-specific UL subband for a UE, the UL transmission may be executed based on the symbol attribute parameters of the DL BWP of the UE.

In some embodiments, if the cell-specific UL subband is configured in the DL symbol or slot, and if a UL transmission is scheduled or configured in the resources of the cell-specific UL subband for a UE (regardless of whether the symbol attribute parameters of the cell-specific UL subband are configured), the UL transmission may be executed based on the symbol attribute parameters of the DL BWP of the UE. In some embodiments, the UL transmission may be executed based on the symbol attribute parameters of the UL BWP of the UE.

In some embodiments, if the cell-specific UL subband is configured in the flexible symbol or slot, and if a UL transmission is scheduled or configured in the resources of the cell-specific UL subband for a UE (regardless of whether the symbol attribute parameters of the cell-specific UL subband may be configured), the UL transmission may be executed based on the symbol attribute parameters of the UL BWP of the UE. In some embodiments, the UL transmission may be executed based on the symbol attribute parameters of the DL BWP of the UE.

In some embodiments, if the cell-specific UL subband is configured in the DL symbol or slot converted from the flexible symbol or slot, and if a UL transmission is scheduled or configured in the resources of the cell-specific UL subband for a UE (regardless of whether the symbol attribute parameters of the cell-specific UL subband are configured), then the UL transmission may be executed based on the symbol attribute parameters of the DL BWP of the UE. In some embodiments, the UL transmission is executed based on the symbol attribute parameters of the UL BWP of the UE.

In some embodiments, if the cell-specific UL subband is configured in the DL symbol or slot, and if a UL transmission is scheduled or configured in the resources of the cell-specific UL subband for a UE (regardless of whether the symbol attribute parameters of the cell-specific UL subband may be configured), the UL transmission may be executed based on the symbol attribute parameters of the DL symbol. In some embodiments, the UL transmission may be executed based on the symbol attribute parameters of the UL symbol.

In some embodiments, if the cell-specific UL subband is configured in the flexible symbol or slot, and if a UL transmission is scheduled or configured in the resources of the cell-specific UL subband for a UE (regardless of whether the symbol attribute parameters of the cell-specific UL subband are configured), the UL transmission may be executed based on the symbol attribute parameters of the flexible symbol. In some embodiments, In some embodiments, the UL transmission may be executed based on the symbol attribute parameters of the UL symbol.

In some embodiments, if the cell-specific UL subband is configured in the DL symbol or slot converted from the flexible symbol or slot, and if a UL transmission is scheduled or configured in the resources of the cell-specific UL subband for a UE (regardless of whether the symbol attribute parameters of the cell-specific UL subband may be configured), then the UL transmission may be executed based on the symbol attribute parameters of the DL symbol In some embodiments, the UL transmission may be executed based on the symbol attribute parameters of the UL symbol.

In some embodiments, the base station and UE agree that the symbol attribute parameters of the cell-specific UL subband are the same as the symbol attribute parameters of the symbols of the cell-specific UL subband by default. In some embodiments, the base station and UE may agree that the symbol attribute parameters of the cell-specific UL subband are the same as those of the UL BWP by default. In some embodiments, the base station and UE may agree that the symbol attribute parameters of the cell-specific UL subband are the same as those of the DL BWP by default.

### B. Configuration of Resources of UE-Specific Uplink (UL) Subband

### I. Configuration Architecture of UL Subband

The base station and UE may agree that only the resources of the UE-specific UL subband may be configured, and the resources of the cell-specific UL subband may not be configured. Table 2 may be referred to for some specific configurations.

TABLE 2
Configuration of UE-specific UL subband

| | Resource of | Candidate resource set of | SCS and/or CP |
|---|---|---|---|
| | UE-specific | channel/signal of | of UE-specific |
| index | UL subband | UE-specific UL subband | UL subband |
| 0 | 1 | 0 | 0 |
| 1 | 1 | 0 | 1 |
| 2 | 1 | 1 | 0 |
| 3 | 1 | 1 | 1 |

Note:
“1” may indicate that the corresponding item is configured; “0” may indicate that the corresponding item may not be configured.

For the convenience of description below, the candidate resource set of the uplink channel/signal may be referred to as the resource set C, and the SCS and/or CP may be referred to as the symbol attribute parameters.

The resources for a UE-specific UL subband may be configured by the base station based on point-to-point signaling for UE. That is, different UEs in the cell may be configured with a UE-specific UL subband. However, from the base station side, it may be better that the UL subbands of different UEs are in a continuous frequency range. In this way, the base station may always perform the reception of the UL subbands of different UEs in the continuous frequency range. It may be beneficial for the base station to lock the frequency domain resource range of the reception in order to reduce costs.

Corresponding to the index 0 in Table 2, the UE-specific UL subband may only be configured with corresponding resources, and the symbol attribute parameters of the UE-specific UL subband may not be configured, and the resource set C corresponding to the UE-specific UL subband may not be configured.

Corresponding to the index 1 in Table 2, the UE-specific UL subband may be configured with corresponding resources, and the symbol attribute parameters of the UE-specific UL subband may also be configured, but the resource set C corresponding to the UE-specific UL subband may not be configured.

Corresponding to the index 2 in Table 2, the UE-specific UL subband may be configured with corresponding resources, and the resource set C corresponding to the UE-specific UL subband may also be configured, but the symbol attribute parameters of the UE-specific UL subband may not be configured.

Corresponding to the index 3 in Table 2, the UE-specific UL subband may be configured with corresponding resources, the resource set C, and the symbol attribute parameters.

For a UE, the resources of the UE-specific UL subband may intersect with its UL BWP resources at least in the frequency domain, and UL transmission may be scheduled or configured in the intersected resources in the SBFD symbol. The resources of the above UE-specific UL subband may include time-domain resources and/or frequency-domain resources.

The candidate resource set of the uplink channel or signal may correspond to the above UE-specific UL subband including: a PUSCH candidate resource set (including k2, where k2 may be the slot interval between the slot where the UL grant may be located and the slot where the corresponding PUSCH transmission may be located), PUCCH resource set (including k1, where k1 may be the slot interval between the slot where the PDSCH may be located and the slot where the corresponding HARQ-ACK PUCCH transmission may be located), PRACH resource or SRS resource.

The above point-to-multipoint signaling may include: system information block, group PDCCH. The above point-to-point signaling may include PDCCH signaling and UE dedicated RRC signaling. For example, the PUSCH candidate resource set may be configured based on the signaling PUSCH-Config in accordance with a specification (e.g., TS38.331), and the PUCCH resource set may be configured based on the signaling PUCCH-Config.

If a UL transmission is scheduled or configured in the resources of the UE-specific UL subband, the UL transmission may be executed based on the symbol attribute parameters of the UE-specific UL subband and the resources selected from the resource set C of the UE-specific UL subband.

II. Improvements to Determining the Resource Set C and/or Symbol Attribute Parameters for UL Transmissions Within the Resource of the UE-Specific UL Subband.

If a UL transmission is scheduled or configured in the resources of the UE-specific UL subband for a UE, and the resource set C of the UE-specific UL subband and the symbol attribute parameters of the UE-specific UL subband are not configured, then the base station and the UE may that the UL transmission is to be executed based on the resource set C of the UL BWP of the UE and the symbol attribute parameters of the UL BWP. That is, from the perspective of the UE, if the resource set C of the UE-specific UL subband is not configured, the base station and the UE may agree that the UE-specific UL subband uses the resource set C of the UL BWP of the UE. If the symbol attribute parameters of the UE-specific UL subband may are not configured, the base station and the UE may agree that the UE-specific UL subband uses the symbol attribute parameters of the UL BWP of the UE.

In some embodiments, if the resource set C of the UE-specific UL subband and/or the symbol attribute parameters of the UE-specific UL subband may not be configured, the base station and the UE may agree that the UL transmission executed based on the resource set C of the initial BWP of the UE and/or based on the symbol attribute parameters of the initial BWP of the UE.

### III. Use of Resource Set C and Symbol Attribute Parameters of UE-Specific UL Subband

In some embodiments, if the resource set C and/or symbol attribute parameters of the UE-specific UL subband are configured, and if a UL transmission is scheduled or configured in the resources of the UE-specific UL subband for a UE, then the base station and the UE may agree:
the UL transmission may be executed based on the symbol attribute parameters and/or resource set C of the UL BWP of the UE. This may be a relatively simple method, but it may not be flexible enough.
or, the base station may indicate by signaling the symbol attribute parameters and/or resource set C used for this UL transmission. For example, the signaling may indicate that the symbol attribute parameters or resource set C of the UL BWP may be used for the UL transmission. For example, the signaling may indicate that the symbol attribute parameters or resource set C of the UE-specific UL subband may be used for the UL transmission. This may be an efficient method, and this may flexibly change the symbol attribute parameters and/or resource set C used by UL transmission according to the scheduling requirements. For example, UE located at the cell edge may be more suitable for using longer CP and larger SCS.

Alternatively, if the resource set C of the UE-specific UL subband and/or the symbol attribute transmission of the UE-specific UL subband are configured, and if a UL transmission related to the initial access (for example, non-competitive initial access) is scheduled or configured for a UE in the resource of the UE-specific UL subband, then the UL transmission may be executed based on the symbol attribute parameters and/or resource set C of the UE-specific UL subband. Here, the UL transmission related to the initial access may include the transmission of the initial access sequence, the PUSCH transmission scheduled by RAR, and the HARQ-ACK PUCCH transmission in the random access process.

IV. Improvements based on Symbol Type (DL symbol or F symbol) of the Symbol Where the UL Subband is Located.

In some embodiments, if the symbol attribute parameters of the UE-specific UL subband are not configured, and if a UL transmission is scheduled or configured in the resources of the UE-specific UL subband for a UE, the UL transmission may be executed based on the symbol attribute parameters of the DL BWP of the UE.

In some embodiments, if the UE-specific UL subband is configured in the DL symbol or slot, and if a UL transmission scheduled or configured in the resources of the UE-specific UL subband for a UE (regardless of whether the symbol attribute parameters of the UE-specific UL subband may be configured), the UL transmission may be executed based on the symbol attribute parameters of the DL BWP of the UE In some embodiments, the UL transmission may be executed based on the symbol attribute parameters of the UL BWP of the UE.

In some embodiments, if the UE-specific UL subband is configured in the flexible symbol or slot, and if a UL transmission is scheduled or configured in the resources of the UE-specific UL subband for a UE (regardless of whether the symbol attribute parameters of the UE-specific UL subband may be configured), the UL transmission may be executed based on the symbol attribute parameters of the UL BWP of the UE In some embodiments, the UL transmission may be executed based on the symbol attribute parameters of the DL BWP of the UE.

In some embodiments, if the UE-specific UL subband is configured in the DL symbol or slot converted from the flexible symbol or slot, and if a UL transmission is scheduled or configured in the resources of the UE-specific UL subband for a UE (regardless of whether the symbol attribute parameters of the UE-specific UL subband may be configured), then the UL transmission may be executed based on the symbol attribute parameters of the DL BWP of the UE. In some embodiments, the UL transmission may be executed based on the symbol attribute parameters of the UL BWP of the UE.

In some embodiments, if the UE-specific UL subband is configured in the DL symbol or slot, and if a UL transmission is scheduled or configured in the resources of the UE-specific UL subband for a UE (regardless of whether the symbol attribute parameters of the UE-specific UL subband may be configured), the UL transmission may be executed based on the symbol attribute parameters of the DL symbol. In some embodiments, the UL transmission may be executed based on the symbol attribute parameters of the UL symbol).

In some embodiments, if the UE-specific UL subband is configured in the flexible symbol or slot, and if a UL transmission is scheduled or configured in the resources of the UE-specific UL subband for a UE (regardless of whether the symbol attribute parameters of the UE-specific UL subband may be configured), the UL transmission may be executed based on the symbol attribute parameters of the flexible symbol. In some embodiments, the UL transmission may be executed based on the symbol attribute parameters of the UL symbol.

In some embodiments, if the UE-specific UL subband is configured in the DL symbol or slot converted from the flexible symbol or slot, and if a UL transmission is scheduled or configured in the resources of the UE-specific UL subband for a UE (regardless of whether the symbol attribute parameters of the UE-specific UL subband may be configured), then the UL transmission may be executed based on the symbol attribute parameters of the DL symbol. In some embodiments, the UL transmission may be executed based on the symbol attribute parameters of the UL symbol.

In some embodiments, the base station and UE may agree that the symbol attribute parameters of the UE-specific UL subband are the same as the symbol attribute parameters of the symbols of the UE-specific UL subband by default. In some embodiments, the base station and UE may agree that the symbol attribute parameters of the UE-specific UL subband are the same as those of the UL BWP by default. In some embodiments, the base station and UE may agree that the symbol attribute parameters of the UE-specific UL subband are the same as those of the DL BWP by default.

### C. Configuration of Resources for Cell-Specific and UE-Specific Uplink (UL) Subbands

### I. Configuration Architecture of UL Subband

The base station and UE may agree that the resources of the cell-specific UL subband are configured, and the resources of the UE-specific UL subband may also be configured. Table 3-1 may be referred to for some specific configurations.

TABLE 3-1
Configuration of UE-specific UL subband and cell-specific UL subband

| | | | SCS | | | SCS |
|---|---|---|---|---|---|---|
| | Resource | Candidate | and/or CP | Resource | Candidate | and/or CP |
| | of cell- | resource set of | of cell- | of UE- | resource set of | of UE- |
| | specific | channel/signal | specific | specific | channel/signal | specific |
| | UL | of cell-specific | UL | UL | of UE-specific | UL |
| index | subband | UL subband | subband | subband | UL subband | subband |
| 0 | 1 | 0 | 0 | 1 | 0 | 0 |
| 1 | 1 | 0 | 1 | 1 | 0 | 0 |
| 2 | 1 | 1 | 0 | 1 | 0 | 0 |
| 3 | 1 | 1 | 1 | 1 | 0 | 0 |
| 4 | 1 | 0 | 0 | 1 | 0 | 1 |
| 5 | 1 | 0 | 1 | 1 | 0 | 1 |
| 6 | 1 | 1 | 0 | 1 | 0 | 1 |
| 7 | 1 | 1 | 1 | 1 | 0 | 1 |
| 8 | 1 | 0 | 0 | 1 | 1 | 0 |
| 9 | 1 | 0 | 1 | 1 | 1 | 0 |
| 10 | 1 | 1 | 0 | 1 | 1 | 0 |
| 11 | 1 | 1 | 1 | 1 | 1 | 0 |
| 12 | 1 | 0 | 0 | 1 | 1 | 1 |
| 13 | 1 | 0 | 1 | 1 | 1 | 1 |
| 14 | 1 | 1 | 0 | 1 | 1 | 1 |
| 15 | 1 | 1 | 1 | 1 | 1 | 1 |

Note:
“1” indicates that the corresponding item may be configured; “0” may indicate that the corresponding item may not be configured.

For the convenience of description below, the candidate resource set of the uplink channel or signal may be referred to as the resource set C, and the SCS or CP may be referred to as the symbol attribute parameters.

The resources for a cell-specific UL subband may be configured by the base station based on point-to-multipoint signaling for UE. That is, all UEs in the cell may receive the same signaling to configure a cell-specific UL subband. That is, from the base station side, only one cell-specific UL subband may be configured in the cell. The resources of cell-specific UL subband may be continuous in frequency domain.

The resources for a UE-specific UL subband may be configured by the base station based on point-to-point signaling for UE. That is, different UEs in the cell may be configured with a UE-specific UL subband. However, from the base station side, it may be better that the UL subbands of different UEs may be in a continuous frequency range. In this way, the base station may always perform the reception of the UL subbands of different UEs in the continuous frequency range. It may be beneficial for the base station to lock the frequency domain resource range of the reception in order to reduce costs.

Corresponding to the index 0 in Table 3-1, the cell-specific UL subband may only be configured with corresponding resources, and the symbol attribute parameters of the cell-specific UL subband may not be configured, and the resource set C corresponding to the cell-specific UL subband may not be configured. The UE-specific UL subband may only be configured with corresponding resources, and the symbol attribute parameters of the UE-specific UL subband may not be configured, and the resource set C corresponding to the UE-specific UL subband may not be configured.

Corresponding to the index 1 in Table 3-1, the cell-specific UL subband may be configured with corresponding resources, and the symbol attribute parameters of the cell-specific UL subband may also be configured, but the resource set C corresponding to the cell-specific UL subband may not be configured; The UE-specific UL subband may only be configured with corresponding resources, and the symbol attribute parameters of the UE-specific UL subband may not be configured, and the resource set C corresponding to the UE-specific UL subband may not be configured.

Corresponding to index 2 in Table 3-1, the cell-specific UL subband may be configured with corresponding resources, and the resource set C corresponding to the cell-specific UL subband may also be configured, but the symbol attribute parameters of the cell-specific UL subband may not be configured; The UE-specific UL subband may only be configured with corresponding resources, and the symbol attribute parameters of the UE-specific UL subband may not be configured, and the resource set C corresponding to the UE-specific UL subband may not be configured.

Corresponding to index 3 in Table 3-1, the cell-specific UL subband may be configured with corresponding resources, the resource set C, and the symbol attribute parameters. The UE-specific UL subband may only be configured with corresponding resources, and the symbol attribute parameters of the UE-specific UL subband may not be configured, and the resource set C corresponding to the UE-specific UL subband may not be configured.

Corresponding to the index 4 in Table 3-1, only the cell-specific UL subband may be configured with corresponding resources, and the symbol attribute parameters of the cell-specific UL subband may not be configured, and the resource set C corresponding to the cell-specific UL subband may not be configured. The UE-specific UL subband may be configured with corresponding resources, and the symbol attribute parameters of the UE-specific UL subband may also be configured, but the resource set C corresponding to the UE-specific UL subband may not be configured.

Corresponding to the index 5 in Table 3-1, the cell-specific UL subband may be configured with corresponding resources, and the symbol attribute parameters of the cell-specific UL subband may also be configured, but the resource set C corresponding to the cell-specific UL subband may not be configured; The UE-specific UL subband may be configured with corresponding resources, and the symbol attribute parameters of the UE-specific UL subband may also be configured, but the resource set C corresponding to the UE-specific UL subband may not be configured.

Corresponding to index 6 in Table 3-1, the cell-specific UL subband may be configured with corresponding resources, and the resource set C corresponding to the cell-specific UL subband may also be configured, but the symbol attribute parameters of the cell-specific UL subband may not be configured; The UE-specific UL subband may be configured with corresponding resources, and the symbol attribute parameters of the UE-specific UL subband may also be configured, but the resource set C corresponding to the UE-specific UL subband may not be configured.

Corresponding to index 7 in Table 3-1, the cell-specific UL subband may be configured with corresponding resources, the resource set C, and the symbol attribute parameters. The UE-specific UL subband may be configured with corresponding resources, and the symbol attribute parameters of the UE-specific UL subband may also be configured, but the resource set C corresponding to the UE-specific UL subband may not be configured.

Corresponding to the index 8 in Table 3-1, only the cell-specific UL subband may be configured with corresponding resources, and the symbol attribute parameters of the cell-specific UL subband may not be configured, and the resource set C corresponding to the cell-specific UL subband may not be configured. The UE-specific UL subband may be configured with corresponding resources, and the resource set C corresponding to the UE-specific UL subband may also be configured, but the symbol attribute parameters of the UE-specific UL subband may not be configured;

Corresponding to the index 9 in Table 3-1, the cell-specific UL subband may be configured with corresponding resources, and the symbol attribute parameters of the cell-specific UL subband may also be configured, but the resource set C corresponding to the cell-specific UL subband may not be configured; The UE-specific UL subband may be configured with corresponding resources, and the resource set C corresponding to the UE-specific UL subband may also be configured, but the symbol attribute parameters of the UE-specific UL subband may not be configured;

Corresponding to index 10 in Table 3-1, the cell-specific UL subband may be configured with corresponding resources, and the resource set C corresponding to the cell-specific UL subband may also be configured, but the symbol attribute parameters of the cell-specific UL subband may not be configured; The UE-specific UL subband may be configured with corresponding resources, and the resource set C corresponding to the UE-specific UL subband may also be configured, but the symbol attribute parameters of the UE-specific UL subband may not be configured;

Corresponding to index 11 in Table 3-1, the cell-specific UL subband may be configured with corresponding resources, the resource set C, and the symbol attribute parameters. The UE-specific UL subband may be configured with corresponding resources, and the resource set C corresponding to the UE-specific UL subband may also be configured, but the symbol attribute parameters of the UE-specific UL subband may not be configured;

Corresponding to the index 12 in Table 3-1, the cell-specific UL subband may only be configured with corresponding resources, and the symbol attribute parameters of the cell-specific UL subband may not be configured, and the resource set C corresponding to the cell-specific UL subband may not be configured. The UE-specific UL subband may be configured with corresponding resources, the resource set C, and the symbol attribute parameters.

Corresponding to index 13 in Table 3-1, the cell-specific UL subband may be configured with corresponding resources, and the symbol attribute parameters of the cell-specific UL subband may also be configured, but the resource set C corresponding to the cell-specific UL subband may not be configured; The UE-specific UL subband may be configured with corresponding resources, the resource set C, and the symbol attribute parameters.

Corresponding to index 14 in Table 3-1, the cell-specific UL subband may be configured with corresponding resources, and the resource set C corresponding to the cell-specific UL subband may also be configured, but the symbol attribute parameters of the cell-specific UL subband may not be configured; The UE-specific UL subband may be configured with corresponding resources, the resource set C, and the symbol attribute parameters.

Corresponding to index 15 in Table 3-1, the cell-specific UL subband may be configured with corresponding resources, the resource set C, and the symbol attribute parameters. The UE-specific UL subband may be configured with corresponding resources, the resource set C, and the symbol attribute parameters.

In Table 3-1 above, the best configuration may include that the cell-specific UL subband may be configured only as a time-frequency resource, and may not be configured with symbol attribute parameters and resource set C. However, the UE-specific UL subband may be configured with time-frequency resources, and may also be configured with symbol attribute parameters and/or resource set C. These configurations may be very suitable for UE-specific UL transmission based on symbol attribute parameters and/or resource set C of the UE-specific UL subband.

For a UE, the resources of the cell-specific UL subband, the resources of the UE-specific UL subband and the UL BWP resources at least intersect in the frequency domain, and the UL transmission may be scheduled or configured in the intersected resources. A UE dedicated UL transmission should be scheduled or configured in the intersection resource. For a UE, a common UL transmission may be scheduled or configured in the intersection resource. A common UL transmission may also be scheduled or configured in the resources of the cell-specific UL subband in addition to UE-specific UL subband resources and UL BWP resources.

The resources of the above UE-specific UL subband include time-domain resources and/or frequency-domain resources. The candidate resource set of the uplink channel/signal corresponding to the above UE-specific UL subband includes: PUSCH candidate resource set (including k2, where k2 is the slot interval between the slot where the UL grant may be located and the slot where the corresponding PUSCH transmission is located), PUCCH resource set (including k1, where k1 may be the slot interval between the slot where the PDSCH may be located and the slot where the corresponding HARQ-ACK PUCCH transmission may be located), PRACH resource or SRS resource.

The above point-to-multipoint signaling includes: system information block, group PDCCH. The above point-to-point signaling may include PDCCH signaling and UE dedicated RRC signaling. For example, the PUSCH candidate resource set may be configured based on the signaling PUSCH-Config in accordance with a specification (e.g., TS38.331), and the PUCCH resource set may be configured based on the signaling PUCCH-Config . . .

### II. Improvements to Determining Resource Set C or Symbol Attribute Parameters for UL Transmission Within the Resource of the UL Subband

If a UL transmission is scheduled or configured in the resources of the cell-specific UL subband for a UE, and the resource set C of the cell-specific UL subband and the symbol attribute parameters of the cell-specific UL subband are not configured, the base station and the UE may agree that the UL transmission is executed based on the resource set C of the UL BWP of the UE and the symbol attribute parameters of the UL BWP. That is, from the perspective of the UE, if the resource set C of the cell-specific UL subband is not configured, the base station and the UE may agree that the cell-specific UL subband uses the resource set C of the UL BWP of the UE. If the symbol attribute parameters of the cell-specific UL subband are not configured, the base station and the UE may agree that the cell-specific UL subband uses the symbol attribute parameters of the UL BWP of the UE.

If a UL transmission is scheduled or configured in the resources of the UE-specific UL subband for a UE, and the resource set C of the UE-specific UL subband and the symbol attribute parameters of the UE-specific UL subband are not configured, then the base station and the UE may agree that the UL transmission is executed based on the resource set C of the UL BWP of the UE and the symbol attribute parameters of the UL BWP. From the perspective of the UE, if the resource set C of the UE-specific UL subband is not configured, the base station and the UE may agree that the UE-specific UL subband uses the resource set C of the UL BWP of the UE. If the symbol attribute parameters of the UE-specific UL subband are not configured, the base station and the UE may agree that the UE-specific UL subband uses the symbol attribute parameters of the UL BWP of the UE.

In some embodiments, if the resource set C of the cell-specific UL subband and/or the symbol attribute parameters of the cell-specific UL subband are not configured, the base station and the UE may agree that the UL transmission is executed based on the resource set C of the initial BWP of the UE and/or based on the symbol attribute parameters of the initial BWP of the UE. In some embodiments, if the resource set C of the UE-specific UL subband and/or the symbol attribute parameters of the UE-specific UL subband are not configured, the base station and the UE may agree agree that the UL transmission is executed based on the resource set C of the initial BWP of the UE and/or based on the symbol attribute parameters of the initial BWP of the UE.

In some embodiments, if the resource set C and/or symbol attribute parameters of the cell-specific UL subband are configured, and if the resource set C and/or symbol attribute parameters of the UE-specific UL subband are configured, and if a UL transmission is scheduled or configured in the resources of the UL subband for a UE, then the base station and the UE may agree: that the UL transmission is to be scheduled or configured in the intersection resources of the cell-specific UL subband, the UE-specific UL subband and the UE's UL BWP resources.

In addition, the base station and the UE agree that:
the UL transmission is executed based on the symbol attribute parameters and/or the resource set C of the UE-specific UL subband;
Or the UL transmission is executed based on the symbol attribute parameters and/or the resource set C of the BWP of the UE;
Or the base station indicates by signaling the symbol attribute parameters and/or resource set C used for this UL transmission. For example, the signaling indicates that the symbol attribute parameters and/or resource set C of the UL BWP are used for the UL transmission. For example, the signaling indicates that the symbol attribute parameters and/or resource set C of the UE-specific UL subband are used for the UL transmission. For example, the signaling indicates that the symbol attribute parameters and/or resource set C of the cell-specific UL subband may be used for the UL transmission.
   III. Determination and Use of Resource Set C and Symbol Attribute Parameters of UL subband.

In some embodiments, the base station and UE agree to determine the symbol attribute parameters and/or resource set C used by the UL transmission according to the transmission type of the scheduled UL transmission. The symbol attribute parameter and/or the resource set C can be determined from the symbol attribute parameter and/or the resource set C of cell-specific UL subband, UE-specific UL subband, UL BWP or DL BWP. The transmission types of UL transmission may include: UE dedicated UL transmission, public UL transmission, UL transmission after random access, and UL transmission during random access.

In some embodiments, the base station and UE agree to determine the symbol attribute parameters used by the UL transmission according to the resource location of the UL transmission. The symbol attribute parameter can be determined from the symbol attribute parameters of cell-specific UL subband, UE-specific UL subband, or UL BWP. The resource location of UL transmission includes: UL transmission is located in the resources of cell-specific UL subband but not in the resources of UE-specific UL subband, and UL transmission located in the resources of UE-specific UL subband. If the UL transmission is in the resource of the cell-specific UL subband but not in the resource of the UE-specific UL subband, the UL transmission may be executed based on the symbol attribute parameters of the cell-specific UL subband. If the UL transmission is in the resource of UE-specific UL subband, the UL transmission may be executed based on the symbol attribute parameters of UE-specific UL subband or UL BWP.

In some embodiments, if the resource set C of the cell-specific UL subband and/or the symbol attribute transmission of the cell-specific UL subband are configured, and if a UL transmission related to the initial access is scheduled or configured for a UE in the resource of the cell-specific UL subband, then the UL transmission may be executed based on the symbol attribute parameters and/or resource set C of the cell-specific UL subband. Here, the UL transmission related to the initial access may include the transmission of the initial access sequence, the PUSCH transmission scheduled by RAR, and the HARQ-ACK PUCCH transmission in the random access process.

In some embodiments, if the resource set C of the cell-specific UL subband and/or the symbol attribute transmission of the cell-specific UL subband are configured, and if a common UL transmission is scheduled or configured in the resource of the cell-specific UL subband for a UE, then the UL transmission may be executed based on the symbol attribute parameter and/or resource set C of the cell-specific UL subband.

In some embodiments, if the resource set C of the UE-specific UL subband and/or the symbol attribute transmission of the UE-specific UL subband are configured, and if a UL transmission related to the initial access (for example, non-competitive initial access) may be scheduled or configured for a UE in the resource of the UE-specific UL subband, then the UL transmission may be executed based on the symbol attribute parameters and/or resource set C of the UE-specific UL subband. Here, the UL transmission related to the initial access includes the transmission of the initial access sequence, the PUSCH transmission scheduled by RAR, and the HARQ-ACK PUCCH transmission in the random access process.

IV. Improvements Based on the Symbol Type (DL Symbol or F symbol) of the Symbol where the UL Subband is Located

In some embodiments, if the symbol attribute parameters of the cell-specific UL subband are not configured, and if a UL transmission is scheduled or configured in the resources of the cell-specific UL subband for a UE, the UL transmission may be executed based on the symbol attribute parameters of the DL BWP (or UL BWP) of the UE. In some embodiments, the UL transmission is executed based on the symbol attribute parameters of the symbol attribute parameters of the UE-specific UL subband (if configured).

In some embodiments, if the cell-specific UL subband is configured in the DL symbol or slot, and if a UL transmission is scheduled or configured in the resources of the cell-specific UL subband for a UE (regardless of whether the symbol attribute parameters of the cell-specific UL subband are configured), the UL transmission may be executed based on the symbol attribute parameters of the DL BWP (or UL BWP) of the UE. In some embodiments, the UL transmission may be executed based on the symbol attribute parameters of the symbol attribute parameters of the UE-specific UL subband (if configured), or the UL transmission may be executed based on the symbol attribute parameters of the DL (or UL) symbol.

In some embodiments, if the cell-specific UL subband is configured in the flexible symbol or slot, and if a UL transmission is scheduled or configured in the resources of the cell-specific UL subband for a UE (regardless of whether the symbol attribute parameters of the cell-specific UL subband are configured), the UL transmission may be executed based on the symbol attribute parameters of the UL BWP (or DL BWP) of the UE. In some embodiments, the UL transmission is executed based on the symbol attribute parameters of the symbol attribute parameters of the UE-specific UL subband (if configured), or the UL transmission is executed based on the symbol attribute parameters of the flexible (or UL) symbol.

In some embodiments, if the cell-specific UL subband is configured in the DL symbol or slot converted from the flexible symbol or slot, and if a UL transmission is scheduled or configured in the resources of the cell-specific UL subband for a UE (regardless of whether the symbol attribute parameters of the cell-specific UL subband are configured), then the UL transmission may be executed based on the symbol attribute parameters of the DL BWP (or UL BWP) of the UE. In some embodiments, the UL transmission may be executed based on the symbol attribute parameters of the symbol attribute parameters of the UE-specific UL subband (if configured), or the UL transmission may be executed based on the symbol attribute parameters of the DL (or UL) symbol.

In some embodiments, the base station and UE may agree that the symbol attribute parameters of the UE-specific UL subband and cell-specific UL subband are the same as the symbol attribute parameters of the symbols of the UE-specific UL subband by default. In some embodiments, the base station and UE may agree that the symbol attribute parameters of the UE-specific UL subband and cell-specific UL subband are the same as those of the UL BWP by default. In some embodiments, the base station and UE may agree that the symbol attribute parameters of the UE-specific UL subband and cell-specific UL subband are the same as those of the DL BWP by default.

### V. Using Intersection of Frequency Domain Resources for UL Subband

In addition, if the resources of cell-specific UL subband are configured and the resources of UE-specific UL subband are not configured, the frequency domain resources of UE-specific UL subband may be the intersection of the frequency domain resources of cell-specific UL subband and the frequency domain resources of UL BWP or initial BWP by default. The time domain resources of UE-specific UL subband may be the same as those of cell-specific UL subband. The resource set C and symbol attribute parameters of UE-specific UL subband can be configured. Table 3-2 may be referred to.

Table 3-2 provides a configuration method for cell-specific UL subband and UE-specific UL subband. In Table 3-2, the resource set C or symbol attribute parameters corresponding to UE-specific UL subband may be configured, but the corresponding resources may not be configured.

For example, in index 0 of Table 3-2, only the resources of cell-specific UL subband are configured. UL transmission can be only scheduled or configured in the intersection resources of frequency domain resources of cell-specific UL subband and frequency domain resources of UL BWP (or initial UL BWP). The UL transmission may be executed based on the resource set C and/or symbol attribute parameters of UL BWP (or initial BWP).

In index 12 of Table 3-2, the resources of cell-specific UL subband may be configured, but the corresponding resource set C and symbol attribute parameters may not be configured. The resources of UE-specific UL subband may not be configured, but the corresponding resource set C and symbol attribute parameters may be configured. UL transmission can only be scheduled or configured in the intersection of the frequency domain resources of the cell-specific UL subband and the frequency domain resources of the UL BWP (or initial UL BWP). The UL transmission is executed based on the resource set C and symbol attribute parameters of UE-specific UL subband.

Based on the configuration of cell-specific UL subband and UE-specific UL subband provided in Table 3-2, the method in the above embodiments can be reused for the configuration of each row.

TABLE 3-2

| | | | SCS | | | SCS |
|---|---|---|---|---|---|---|
| | Resource | Candidate | and/or CP | Resource | Candidate | and/or CP |
| | of cell- | resource set of | of cell- | of UE- | resource set of | of UE- |
| | specific | channel/signal | specific | specific | channel/signal | specific |
| | UL | of cell-specific | UL | UL | of UE-specific | UL |
| index | subband | UL subband | subband | subband | UL subband | subband |
| 0 | 1 | 0 | 0 | 0 | 0 | 0 |
| 1 | 1 | 0 | 1 | 0 | 0 | 0 |
| 2 | 1 | 1 | 0 | 0 | 0 | 0 |
| 3 | 1 | 1 | 1 | 0 | 0 | 0 |
| 4 | 1 | 0 | 0 | 0 | 0 | 1 |
| 5 | 1 | 0 | 1 | 0 | 0 | 1 |
| 6 | 1 | 1 | 0 | 0 | 0 | 1 |
| 7 | 1 | 1 | 1 | 0 | 0 | 1 |
| 8 | 1 | 0 | 0 | 0 | 1 | 0 |
| 9 | 1 | 0 | 1 | 0 | 1 | 0 |
| 10 | 1 | 1 | 0 | 0 | 1 | 0 |
| 11 | 1 | 1 | 1 | 0 | 1 | 0 |
| 12 | 1 | 0 | 0 | 0 | 1 | 1 |
| 13 | 1 | 0 | 1 | 0 | 1 | 1 |
| 14 | 1 | 1 | 0 | 0 | 1 | 1 |
| 15 | 1 | 1 | 1 | 0 | 1 | 1 |

### D. Configuration of Physical Uplink Shared Channel (PUSCH) Candidate Resource Sets

In the subband full duplex technology, the PUSCH candidate resource set may be configured for SBFD slot and non-SBFD slot respectively, but this application may believe that the above method has the following problems.

### I. Problem Description

Table 4 below may be the PUSCH candidate resource set configured for SBFD slot through the signaling PUSCH-config in accordance with a specification (e.g., TS38.331). Furthermore, Table 5 below may be the PUSCH candidate resource set configured for non-SBFD slot through the signaling PUSCH-config.

If the UE receives downlink control information (DCI) (also called UL grant) from the PDCCH for scheduling a PUSCH transmission, UE cannot determine whether the PUSCH resource allocation indicator (e.g., the row index of the PUSCH candidate resource set) in the UL grant is understood to be based on Table 4 or Table 5. It may be easy to think that if the location of the slot that will transmit the PUSCH transmission, it may be determined based on the UL grant, then the type of the slot (e.g., SBFD slot or non-SBFD slot) can be determined based on the configuration pattern of the SBFD slot. In this way, the PUSCH resource allocation indicator may also be correctly understood based on the type of the slot, since Table 4 is associated with the SBFD slot and Table 5 is associated with the non-SBFD slot.

However, in a PUSCH candidate resource set, each PUSCH resource may be associated with a parameter k2, which may describe the slot interval between the slot where the UL grant may be located and the slot where the PUSCH transmission may be located. Therefore, the PUSCH resource allocation indicator may not only indicate the PUSCH resource corresponding to the PUSCH transmission, but may also indicate the slot location corresponding to the PUSCH transmission. Therefore, before the understanding of the PUSCH resource allocation indicator may be determined, the slot location of the PUSCH transmission cannot be determined.

For example, the value of the PUSCH resource allocation indicator is 0, that is, index 0, but UE cannot determine whether index 0 may be understood to be based on table 4 or table 5, so UE cannot determine the PUSCH resource corresponding to the PUSCH transmission and the slot location corresponding to the PUSCH transmission.

TABLE 4

| | | | Length of PUSCH |
|---|---|---|---|
| | | | (number of |
| | | | consecutive |
| | | Index of PUSCH | symbols from the |
| index | k2 | start symbol | start symbol) |
| 0 | 1 | 0 | 4 |
| 1 | 0 | 4 | 8 |
| 2 | 2 | 2 | 10 |

TABLE 5

| | | | Length of PUSCH |
|---|---|---|---|
| | | | (number of |
| | | | consecutive |
| | | Index of PUSCH | symbols from the |
| index | k2 | start symbol | start symbol) |
| 0 | 2 | 2 | 6 |
| 1 | 1 | 5 | 8 |
| 2 | 0 | 3 | 10 |

The following solutions are provided for the above problems.

### II. Method 1

A new parameter A may be added to the UL grant. Parameter A may be used to indicate whether the PUSCH resource allocation indicator in the UL grant may be based on the PUSCH candidate resource set configured for the SBFD slot or on the PUSCH candidate resource set configured for the non-SBFD slot.

In some embodiments, parameter A may be used to indicate that the UL grant itself may be based on the PUSCH candidate resource set configured for the SBFD slot or on the PUSCH candidate resource set configured for the non-SBFD slot.

In some embodiments, parameter A may be used to indicate whether the UL grant itself may be based on SBFD slot (and the corresponding configuration associated with the SBFD slot) or based on non-SBFD slot (and the corresponding configuration associated with the non-SBFD slot).

The base station indicates whether the UL grant may be based on SBFD slot (and the corresponding configuration associated with the SBFD slot) or based on non-SBFD slot (and the corresponding configuration associated with the non-SBFD slot) by setting the value of parameter A. UE also determines whether the UL grant is may be based on SBFD slot (and the corresponding configuration associated with the SBFD slot) or based on non-SBFD slot (and the corresponding configuration associated with the non-SBFD slot) according to the value of parameter A in the UL grant.

### III. Method 2

A new parameter B may be added to the UL grant. Parameter B may be used to indicate whether the PUSCH transmission scheduled in the UL grant may be based on the SCS and/or CP of the UL subband, or based on the SCS and/or CP of the UL BWP. The base station and the UE may also agree that if parameter B indicates that the PUSCH transmission is based on the SCS and/or CP of the UL subband, then the PUSCH resource allocation indicator corresponding to the PUSCH transmission may be also based on the PUSCH candidate resource set of the UL subband (e.g., based on the PUSCH candidate resource set configured for the SBFD slot). If parameter B indicates that the PUSCH transmission is based on the SCS and/or CP of the UL BWP, then the PUSCH resource allocation indicator corresponding to the PUSCH transmission may be based on the PUSCH candidate resource set of the UL BWP (e.g., based on the PUSCH candidate resource set configured for the non-SBFD slot).

In some embodiments, parameter B may be used to indicate that the UL grant itself on the SCS and/or CP of the UL subband, or based on the SCS and/or CP of the UL BWP. The base station and the UE may also agree that if parameter B indicates that the UL grant itself is based on the SCS and/or CP of the UL subband, then the PUSCH resource allocation indicator corresponding to the PUSCH transmission may also be based on the PUSCH candidate resource set of the UL subband (e.g., based on the PUSCH candidate resource set configured for the SBFD slot). If parameter B indicates that UL grant itself is based on the SCS and/or CP of the UL BWP, then the PUSCH resource allocation indicator corresponding to the PUSCH transmission may be on the PUSCH candidate resource set of the UL BWP (e.g., based on the PUSCH candidate resource set configured for the non-SBFD slot).

In some embodiments, parameter B may be used to indicate that the UL grant itself may be based on the UL subband (and the corresponding configuration associated with the UL subband), or based on the UL BWP (and the configuration associated with the UL BWP). The base station and the UE may also agree that if parameter B indicates that the UL grant itself is based on the UL subband, then the PUSCH resource allocation indicator corresponding to the PUSCH transmission may also be based on the PUSCH candidate resource set of the UL subband (e.g., based on the PUSCH candidate resource set configured for the SBFD slot). If parameter B indicates that the UL grant itself is based on the UL BWP, then the PUSCH resource allocation indicator corresponding to the PUSCH transmission may be based on the PUSCH candidate resource set of the UL BWP (e.g., based on the PUSCH candidate resource set configured for the non-SBFD slot). The UL subband here can be cell-specific UL subband or UE-specific UL subband.

### IV. Method 3

For the UE, the PUSCH candidate resource set corresponding to the SBFD slot (marked as Table 6) and the PUSCH candidate resource set corresponding to the non-SBFD slot (marked as Table 7) may be respectively configured by the base station, and the same row index in Table 6 and Table 7 may be configured with the same k2 value.

See Table 6 and Table 7 below for an example. The k2 value corresponding to index 0 in Table 6 may be equal to the k2 value corresponding to index 0 in Table 7. The k2 value corresponding to index 1 in Table 6 may be equal to the k2 value corresponding to index 1 in Table 7. The k2 value corresponding to index 2 in Table 6 may be equal to the k2 value corresponding to index 2 in Table 7.

In this way, after the UE may receive the UL grant that schedules the PUSCH transmission, a unique k2 value can be determined from Table 6 and Table 7 according to the PUSCH resource allocation indicator in the UL grant. Then the slot where the PUSCH transmission is located can be determined based on the slot where the UL grant may be located and the determined k2 value. Further, the type of the slot (SBFD slot or non-SBFD slot) can be determined based on the SBFD slot configuration pattern. Then,
According to the type of the slot, the PUSCH resource allocation indicator in the UL grant can be determined to be based on Table 6 or Table 7;
According to the type of the slot, the PUSCH transmission scheduled by the UL grant can be determined based on the SCS and/or CP of UL subband, or the SCS and/or CP of UL BWP; and
According to the type of the slot, the UL grant itself can be determined to be based on UL subband (and the corresponding configuration associated with the UL subband) or UL BWP (and the configuration associated with the UL BWP).

TABLE 6

| | | | Length of PUSCH |
|---|---|---|---|
| | | | (number of |
| | | | consecutive |
| | | Index of PUSCH | symbols from the |
| index | k2 | start symbol | start symbol) |
| 0 | 0 | 0 | 4 |
| 1 | 2 | 4 | 8 |
| 2 | 1 | 2 | 10 |

TABLE 7

| | | | Length of PUSCH |
|---|---|---|---|
| | | | (number of |
| | | | consecutive |
| | | Index of PUSCH | symbols from the |
| index | k2 | start symbol | start symbol) |
| 0 | 0 | 2 | 6 |
| 1 | 2 | 5 | 8 |
| 2 | 1 | 3 | 10 |

### V. Method 4

New columns may be added as PUSCH candidate resource set for SBFD slot in the existing PUSCH candidate resource set. The base station and UE may agree that the “Index of PUSCH start symbol” and “Length of PUSCH” in the existing PUSCH candidate resource set may be for non-SBFD slot or for UL BWP. The “(new) Index of PUSCH start symbol for SBFD slot” and “(new) Length of PUSCH for SBFD slot” added to the existing PUSCH candidate resource set are for SBFD slot or for UL subband. An example is shown in Table 8.

In this way, after the UE receives the UL grant that schedules the PUSCH transmission, a unique k2 value can be determined from Table 8 according to the PUSCH resource allocation indicator in the UL grant. Then the slot where the PUSCH transmission may be located can be determined based on the slot where the UL grant may be located and the determined k2 value. Further, the type of the slot (SBFD slot or non-SBFD slot) can be determined based on the SBFD slot configuration pattern. Then:
According to the type of the slot, the PUSCH resource allocation indicator in the UL grant can be determined based on the columns of the associated PUSCH resource for SBFD slot or based on the columns of the associated PUSCH resource for non-SBFD slot;
And according to the type of the slot, the PUSCH transmission scheduled by the UL grant can be determined based on the SCS and/or CP of UL subband, or the SCS and/or CP of UL BWP;
And according to the type of the slot, the UL grant itself can be determined to be based on UL subband (and the corresponding configuration associated with the UL subband) or UL BWP (and the configuration associated with the UL BWP).

TABLE 8

| | | | | | (new)Length |
|---|---|---|---|---|---|
| | | | Length of | | of PUSCH |
| | | | PUSCH | | (number of |
| | | | (number of | | consecutive |
| | | | consecutive | (new)Index | symbols |
| | | | symbols | of PUSCH | from the |
| | | Index of | from the | start symbol | start |
| | | PUSCH | start | for SBFD | symbol) for |
| index | k2 | start symbol | symbol) | slot | SBFD slot |
| 0 | 0 | 2 | 6 | 0 | 4 |
| 1 | 2 | 5 | 8 | 4 | 8 |
| 2 | 1 | 3 | 10 | 2 | 10 |

E. Determining Repetition Factor in Hybrid Automatic Repeat Request Acknowledgement (HARQ-ACK) Physical Uplink Control Channel (PUCCH)

The following is an embodiment about determining the repetition factor of Hybrid automatic repeat request acknowledgement (HARQ-ACK) Physical uplink control channel (PUCCH) for msg4 or the Physical downlink shared channel (PDSCH) scheduled by Downlink control information (DCI) scrambled by MsgB-RNTI. The msg4 may be a PDSCH with UE content resolution identity in the 4-step random access procedure. The PDSCH scheduled by DCI scrambled by MsgB-RNTI may be in the second step of the 2-step random access procedure. The following provides several potential options to determine the repetition factor of the HARQ-ACK PUCCH.

### I. Option 1

For base station reception and UE transmission, the repetition factor of HARQ-ACK PUCCH corresponding to msg4 may be determined based on the repetition factor of the PUSCH scheduled by RAR grant (also called msg3). For example, the repetition factor of the PUCCH may be determined by reducing the repetition factor of the PUSCH. For example, if the repetition factor of the PUSCH is determined to be equal to 8, then the repetition factor of the PUCCH may be determined to be less than 8. For example, a scaling factor can be determined from these values of 0.9, 0.8, 0.7, 0.6, 0.5, 0.95, 0.85, 0.75, 0.65 and 0.55. The scaling factor can be sent in the system information block (SIB). The repetition factor of the PUCCH may be determined as the value obtained by multiplying the repetition factor of the PUSCH by the determined scaling factor to be rounded up (or down). The UE may transmit the HARQ-ACK PUCCH based on the repetition factor indicated in DCI. The base station receives the HARQ-ACK PUCCH based on the repetition factor indicated in the DCI.

### II. Option 2

For the base station receiving and UE transmitting a HARQ-ACK PUCCH of msg4, if the repetition factor of the HARQ-ACK PUCCH of msg4 may be not configured in the SIB, then the behavior of UE and the base station: the UE sends the request to the base station for a repetition factor of the HARQ-ACK PUCCH, then the repetition factor of the HARQ-ACK PUCCH of msg4 may be dynamically indicated by the base station in the DCI corresponding to msg4. The UE may transmit the HARQ-ACK PUCCH based on the repetition factor indicated in DCI. The base station may receive the HARQ-ACK PUCCH based on the repetition factor indicated in the DCI.

For the base station receiving and UE transmitting a HARQ-ACK PUCCH of msg4, if only one repetition factor of the HARQ-ACK PUCCH corresponding to msg4 may be configured in the SIB, then the behavior of the base station and UE may be as follows: the UE may send the request to the base station for a repetition factor of the HARQ-ACK PUCCH, then the repetition factor of the HARQ-ACK PUCCH of msg4 may be dynamically indicated by the base station in the DCI scheduling msg4, However, if the repetition factor of HARQ-ACK PUCCH of msg4 may be not dynamically indicated by the base station in the DCI scheduling msg4, the above repetition factor in the SIB may be used. Wherein, the indicated repetition factor may be a repetition factor other than the above repetition factor in the SIB. UE may transmit the HARQ-ACK PUCCH based on the finally determined repetition factor. The base station may receive the HARQ-ACK PUCCH based on the finally determined repetition factor.

### III. Option 3

For the base station receiving and UE transmitting a HARQ-ACK PUCCH of msg4, if the repetition factor of the HARQ-ACK PUCCH of msg4 may be not configured in the SIB, the behavior of the base station and UE may be as follows: the UE may send a request to the base station for a repetition factor of the HARQ-ACK PUCCH, then the repetition factor of the HARQ-ACK PUCCH may be equal to the repetition factor of the msg3, or the repetition factor of the HARQ-ACK PUCCH may be determined through the above option 1. UE may transmit the HARQ-ACK PUCCH based on the finally determined repetition factor. The base station may receive the HARQ-ACK PUCCH based on the finally determined repetition factor.

For the base station receiving and UE transmitting a HARQ-ACK PUCCH of msg4, if only one repetition factor of the HARQ-ACK PUCCH corresponding to msg4 may be configured in the SIB, then the behavior of the base station and UE may be as follows: the behavior of the base station and UE: the UE may send a request to the base station for a repetition factor of the HARQ-ACK PUCCH, then the repetition factor of the HARQ-ACK PUCCH may be equal to the repetition factor of the msg3, or the repetition factor of the HARQ-ACK PUCCH may be determined through the above option 1. Wherein, the repetition factor in SIB can be different from the repetition factor of the msg3. UE may transmit the HARQ-ACK PUCCH based on the finally determined repetition factor. The base station may receive the HARQ-ACK PUCCH based on the finally determined repetition factor.

### IV. Option 4

For the base station receiving and UE transmitting a HARQ-ACK PUCCH of msg4, if the repetition factor of the HARQ-ACK PUCCH of msg4 may be not configured in the SIB, the behavior of the base station and UE: the UE may send a request to the base station for a repetition factor of the HARQ-ACK PUCCH, then the predefined repetition factor may be used for the HARQ-ACK PUCCH. The predefined repetition factor can be fixed in the specification protocol. UE may transmit the HARQ-ACK PUCCH based on the finally determined repetition factor. The base station may receive the HARQ-ACK PUCCH based on the finally determined repetition factor.

For the base station receiving and UE transmitting a HARQ-ACK PUCCH of msg4, if only one repetition factor of the HARQ-ACK PUCCH corresponding to msg4 may be configured in the SIB, then the behavior of the base station and UE: the UE may send a request to the base station for a repetition factor of the HARQ-ACK PUCCH, then the predefined repetition factor may be used for the HARQ-ACK PUCCH, the predefined repetition factor can be fixed in the specification protocol; Or the predefined repetition factor may be determined based on the above repetition factor in SIB. For example, the predefined repetition factor can be equal to n times of the above repetition factor in SIB, and n can be equal to 2. UE may transmit the HARQ-ACK PUCCH based on the finally determined repetition factor. The base station may receive the HARQ-ACK PUCCH based on the finally determined repetition factor.

### V. Option 5

For the base station receiving and UE transmitting a HARQ-ACK PUCCH of msg4, if the repetition factor of the HARQ-ACK PUCCH of msg4 may be not configured in the SIB, the behavior of the base station and UE may be as follows: UE may report a repetition factor of HARQ-ACK PUCCH to the base station, and the reported repetition factor may be used for the HARQ-ACK PUCCH. UE may transmit the HARQ-ACK PUCCH based on the finally determined repetition factor. The base station may receive the HARQ-ACK PUCCH based on the finally determined repetition factor.

For the base station receiving and UE transmitting a HARQ-ACK PUCCH of msg4, if only one repetition factor of the HARQ-ACK PUCCH corresponding to msg4 may be configured in the SIB, then the behavior of the base station and UE may be as follows: UE may report a repetition factor of HARQ-ACK PUCCH to the base station, and the reported repetition factor may be used for the HARQ-ACK PUCCH. Wherein the repetition factor reported by UE may be different from the above repetition factor in SIB. UE may transmit the HARQ-ACK PUCCH based on the finally determined repetition factor. The base station may receive the HARQ-ACK PUCCH based on the finally determined repetition factor.

### VI. Option 6

For the base station receiving and UE transmitting a HARQ-ACK PUCCH of msg4, if the repetition factor of the HARQ-ACK PUCCH of msg4 may be not configured in the SIB, the behavior of the base station and UE may be as follows: UE may report a repetition factor of HARQ-ACK PUCCH to the base station. If a repetition factor may be indicated by the base station in the DCI of msg4 for the HARQ-ACK PUCCH, the repetition factor indicated by the base station may be used for the HARQ-ACK PUCCH. If no repetition factor may be indicated by the base station in the DCI of msg4, the reported repetition factor may be used for the HARQ-ACK PUCCH. UE may transmit the HARQ-ACK PUCCH based on the finally determined repetition factor. The base station may receive the HARQ-ACK PUCCH based on the finally determined repetition factor.

For the base station receiving and UE transmitting a HARQ-ACK PUCCH of msg4, if only one repetition factor of the HARQ-ACK PUCCH corresponding to msg4 may be configured in the SIB, then the behavior of the base station and UE may be as follows: UE may report a repetition factor of HARQ-ACK PUCCH to the base station. If a repetition factor may be indicated by the base station in the DCI of msg4 for the HARQ-ACK PUCCH, the repetition factor indicated by the base station may be used for the HARQ-ACK PUCCH. If no repetition factor may be indicated by the base station in the DCI of msg4, the reported repetition factor may be used for the HARQ-ACK PUCCH. Wherein the repetition factor reported by UE may be different from the above repetition factor in SIB. UE may transmit the HARQ-ACK PUCCH based on the finally determined repetition factor. The base station may receive the HARQ-ACK PUCCH based on the finally determined repetition factor.

### VII. Option 7

For the base station receiving and UE transmitting a HARQ-ACK PUCCH of msg4, f the repetition factor of the HARQ-ACK PUCCH of msg4 may be not configured in the SIB, the behavior of the base station and UE may be as follows: the UE may send a request to the base station for a repetition factor of the HARQ-ACK PUCCH. If a repetition factor may be indicated by the base station for the HARQ-ACK PUCCH in the DCI of msg4, the indicated repetition factor may be used for the HARQ-ACK PUCCH. If no repetition factor may be indicated in the DCI of msg4, the repetition factor of the HARQ-ACH PUCCH may be equal to the repetition factor of msg3, or the repetition factor of the HARQ-ACH PUCCH may be determined based on the above option 1. UE may transmit the HARQ-ACK PUCCH based on the finally determined repetition factor. The base station may receive the HARQ-ACK PUCCH based on the finally determined repetition factor.

For the base station receiving and UE transmitting a HARQ-ACK PUCCH of msg4, if only one repetition factor of the HARQ-ACK PUCCH corresponding to msg4 may be configured in the SIB, then the behavior of the base station and UE: the UE may send a request to the base station for a repetition factor of the HARQ-ACK PUCCH. If a repetition factor may be indicated by the base station for the HARQ-ACK PUCCH in the DCI of msg4, the indicated repetition factor may be used for the HARQ-ACK PUCCH. If no repetition factor may be indicated in the DCI of msg4, the repetition factor of the HARQ-ACK PUCCH may be equal to the repetition factor of msg3, or the repetition factor of the HARQ-ACK PUCCH may be equal to the repetition factor in the SIB, or the repetition factor of the HARQ-ACH PUCCH may be determined based on the above option 1. UE may transmit the HARQ-ACK PUCCH based on the finally determined repetition factor. The base station may receive the HARQ-ACK PUCCH based on the finally determined repetition factor.

### VII. Option 8

For the base station receiving and UE transmitting a HARQ-ACK PUCCH of msg4, if the repetition factor of the HARQ-ACK PUCCH of msg4 may be configured in the SIB, the behavior of the base station and UE may be as follows: the repetition factor of the PUCCH may be 1 for UE without the repetition ability of the PUCCH. UE may transmit the HARQ-ACK PUCCH based on the finally determined repetition factor. The base station may receive the HARQ-ACK PUCCH based on the finally determined repetition factor.

For the base station receiving and UE transmitting a HARQ-ACK PUCCH of msg4, if only one repetition factor of the HARQ-ACK PUCCH corresponding to msg4 may be configured in the SIB, then the behavior of the base station and UE: the repetition factor of the PUCCH may be 1 for UE without the repetition ability of the PUCCH. UE may transmit the HARQ-ACK PUCCH based on the finally determined repetition factor. The base station may receive the HARQ-ACK PUCCH based on the finally determined repetition factor.

### F. Process for Configuring Resources for Uplink Transmissions

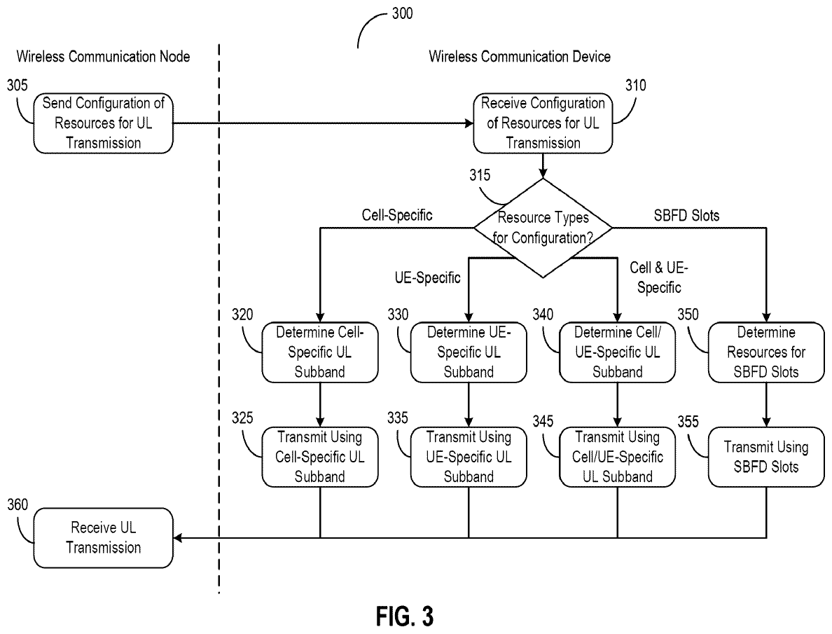

Referring now to FIG. 3, depicted is a flow diagram of a method 300 of configuring resources for uplink transmissions. The method 300 may be implemented using or performed using any of the components detailed herein above, such as the BS 102 or 202 and UE 104 or 204. Under the method 300, a wireless communication node may send a configuration of resources for uplink (UL) transmission (305). A wireless communication device may receive the configuration of resources for UL transmission (310). The wireless communication device may determine a resource type for configuration (315). When the resource type is cell-specific, the wireless communication device may determine a resource for a cell-specific UL subband (320). The wireless communication device may transmit using cell-specific UL subband (325). When the resource type is UE-specific, the wireless communication device may determine a resource for a UE-specific UL subband (330). The wireless communication device may transmit using UE-specific UL subband (335). When the resource type is for cell-specific and UE-specific, the wireless communication device may determine the resource for a cell-specific or UE-specific UL subband (340). The wireless communication device may transmit using cell-specific or UE-specific UL subband (345). When the resource type is for subband full-duplex (SBFD) slots, the wireless communication device may determine the resource for SBFD slots (350). The wireless communication device may transmit using SBFD slots (355). The wireless communication node may receive the UL transmission from the wireless communication device (360).

In further detail, a wireless communication node (e.g., BS 102 or 202) may provide, transmit, or otherwise send a configuration of resources for uplink (UL) transmission to a wireless communication device (e.g., UE 104 or 204) (305). The configuration of resources may be for UL transmission from the wireless communication device to the wireless communication node. The configuration may specify, define, or otherwise identify a resource type for a UL subband to be configured such as: a cell-specific UL subband, a UE-specific UL subband, a combination of cell-specific UL subband, or subband full-duplex (SBFD) slots, among others. The wireless communication device may retrieve, identify, or otherwise receive the configuration of resources for UL transmission from the wireless communication node (310).

The wireless communication device may identify, select, or otherwise determine the resource type for configuration (315). Upon receipt from the wireless communication node, the wireless communication node may identify or determine at least one resource (e.g., frequency or time resources) for an UL subband. In some embodiments, the wireless communication device may parse the received configuration to extract or identify the resource type to be configured, as specified by the wireless communication node. Based on the resource type, the wireless communication device may determine the resource for the UL subband of the wireless communication device for the UL transmission with the wireless communication node.

When the resource type is cell-specific, the wireless communication device may identify or identify, configure, or determine a resource for a cell-specific UL subband (320). In some embodiments, the wireless communication device may determine that the UL transmission is scheduled or configured in resources of the cell-specific UL subband for the wireless communication device. The resources of a cell-specific UL subband may be configured by the configuration. A resource set C may refer to a candidate resource set, and symbol attribute parameters may refer to at least one of a subcarrier spacing or a cyclic prefix.

When the UL transmission is scheduled or configured in resources of the cell-specific UL subband for the wireless communication, the wireless communication device may determine the cell-specific UL subband using the resource set C or the symbol attribute parameters. The determination may be dependent on whether the resource set C or the symbol attribute parameters are configured. If a resource set C of the cell-specific UL subband is not configured, the wireless communication device may determine with the wireless communication node that the cell-specific UL subband uses a resource set C of an UL bandwidth part (BWP) or an initial BWP of the wireless communication device. If symbol attribute parameters of the cell-specific UL subband are not configured, the wireless communication device may determine with the wireless communication node that the cell-specific UL subband uses symbol attribute parameters of the UL BWP or the initial BWP of the wireless communication device.

The wireless communication device may carry out, perform, or execute a UL transmission using the cell-specific UL subband of the wireless communication device to the wireless communication device (325). At least one of: a resource set C or symbol attribute parameters of the cell-specific UL subband may be determined or configured. The UL transmission may have been scheduled or configured in resources of the cell-specific UL subband for the wireless communication device. With the configuration, the wireless communication device may determine with the wireless communication node that the UL transmission is executed based on at least one of symbol attribute parameters or a resource set C. In some embodiments, at least one of symbol attribute parameters or a resource set C may be: (a) of an UL bandwidth part (BWP) of the wireless communication device or (b) indicated by signaling of the wireless communication node. With the determine, the wireless communication device may send the UL transmission on the cell-specific UL subband.

In some embodiments, the cell-specific UL subband may be configured in a downlink (DL) symbol or slot. The UL transmission may be scheduled or configured in resources of the cell-specific UL subband (e.g., corresponding to the DL symbol or slot) for the wireless communication device. The wireless communication device may determine to execute the UL transmission using the DL symbol or slot. In some embodiments, the UL transmission may be executed (e.g., by the wireless communication device) based on symbol attribute parameters of a DL bandwidth part (BWP) of the wireless communication device. In some embodiments, the UL transmission may be executed based on the symbol attribute parameters of an UL BWP of the wireless communication.

In some embodiments, the cell-specific UL subband may be configured in a flexible symbol or slot. The UL transmission may be scheduled or configured in resources of the cell-specific UL subband (e.g., corresponding to the flexible symbol or slot) for the wireless communication device. The wireless communication device may determine to execute the UL transmission using the flexible symbol or slot. In some embodiments, the UL transmission may be executed based on the symbol attribute parameters of an UL bandwidth part (BWP) of the wireless communication device. In some embodiments, the UL transmission may be executed based on symbol attribute parameters of a DL BWP of the wireless communication device.

In some embodiments, the cell-specific UL subband may be configured in a DL symbol or slot converted from a flexible symbol or slot. The UL transmission may be scheduled or configured in resources of the cell-specific UL subband (e.g., corresponding to the converted DL symbol or slot) for the wireless communication device. The wireless communication device may determine to execute the UL transmission using the converted DL symbol or slot. In some embodiments, UL transmission may be executed based on symbol attribute parameters of a DL bandwidth part (BWP) of the wireless communication device. In some embodiments, UL transmission may be executed based on symbol attribute parameters of an UL BWP of the wireless communication device.

When the resource type is UE-specific, the wireless communication device may identify, configure, or determine a resource for a UE-specific UL band (330). In some embodiments, the wireless communication device may determine that the UL transmission is scheduled or configured in resources of the UE-specific UL subband for the wireless communication device. The resources of a UE-specific UL subband may be configured by the configuration. A resource set C may refer to a candidate resource set, and symbol attribute parameters may refer to at least one of a subcarrier spacing or a cyclic prefix.

When the UL transmission is scheduled or configured in resources of the UE-specific UL subband for the wireless communication, the wireless communication device may determine the UE-specific UL subband using the resource set C or the symbol attribute parameters. The determination may be dependent on whether the resource set C or the symbol attribute parameters are configured. If a resource set C of the UE-specific UL subband is not configured, the wireless communication device may determine with the wireless communication node that the UE-specific UL subband uses a resource set C of an UL bandwidth part (BWP) or an initial BWP of the wireless communication device. If symbol attribute parameters of the UE-specific UL subband are not configured, the wireless communication device may determine with the wireless communication node that the UE-specific UL subband uses symbol attribute parameters of the UL BWP or the initial BWP of the wireless communication device.

The wireless communication device may carry out, perform, or execute a UL transmission using the UE-specific UL subband of the wireless communication device to the wireless communication device (335). At least one of a resource set C or symbol attribute parameters of the UE-specific UL subband may be configured. The UL transmission may be scheduled or configured in resources of the UE-specific UL subband for the wireless communication device. With the configuration, the wireless communication device may determine with the wireless communication node that the UL transmission is executed based on at least one of symbol attribute parameters or a resource set C. In some embodiments, at least one of symbol attribute parameters or a resource set C may be: (a) of an UL bandwidth part (BWP) of the wireless communication device; or (b) indicated by signaling of the wireless communication node. With the determine, the wireless communication device may send the UL transmission on the cell-specific UL subband.

In some embodiments, the UE-specific UL subband may be configured in a DL symbol or slot. The UL transmission may be scheduled or configured in resources of the UE-specific UL subband (e.g., corresponding to the DL symbol or slot) for the wireless communication device. The wireless communication device may determine to execute the UL transmission using the DL symbol or slot. In some embodiments, the UL transmission may be executed based on symbol attribute parameters of a DL bandwidth part (BWP) of the wireless communication device. In some embodiments, the UL transmission may be executed based on symbol attribute parameters of an UL BWP of the wireless communication device.

In some embodiments, the UE-specific UL subband may be configured in a flexible symbol or slot. The UL transmission is scheduled or configured in resources of the UE-specific UL subband (e.g., corresponding to the flexible symbol or slot) for the wireless communication device. The wireless communication device may determine to execute the UL transmission using the flexible symbol or slot. In some embodiments, the UL transmission may be executed based on symbol attribute parameters of an UL bandwidth part (BWP) of the wireless communication device. In some embodiments, the UL transmission may be executed based on symbol attribute parameters of a DL BWP of the wireless communication device.

In some embodiments, the UE-specific UL subband may be configured in a DL symbol or slot converted from the flexible symbol or slot. The UL transmission is scheduled or configured in resources of the UE-specific UL subband (e.g., corresponding to the converted DL symbol or slot) for the wireless communication device. The wireless communication device may determine to execute the UL transmission using the converted DL symbol or slot. In some embodiments, the UL transmission may be executed based on symbol attribute parameters of a DL bandwidth part (BWP) of the wireless communication device. In some embodiments, the UL transmission may be executed based on symbol attribute parameters of an UL BWP of the wireless communication device.

When the resource type is for cell-specific and UE-specific, the wireless communication device may identify, configure, or determine a resource for cell-specific UL subband or UE-specific UL subband, or both (340). In some embodiments, the wireless communication device may determine that the UL transmission is scheduled or configured in resources of the cell-specific UL subband or the UE-specific UL subband for the wireless communication device. The resources of a cell-specific UL subband may be configured by the configuration and resources of a UE-specific UL subband may be also configured by the configuration. A resource set C may refer to a candidate resource set, and (ii) symbol attribute parameters may refer to at least one of a subcarrier spacing or a cyclic prefix.

When the UL transmission is scheduled or configured in resources of the cell-specific UL subband or the UE-specific UL subband for the wireless communication, the wireless communication device may determine the cell-specific UL subband or the UE-specific UL subband using the resource set C or the symbol attribute parameters. The determination may be dependent on whether the resource set C or the symbol attribute parameters are configured. In some embodiments, the UL transmission may be scheduled or configured in resources of the cell-specific UL subband for the wireless communication device. In some embodiments, the UL transmission may be scheduled or configured in resources of the UE-specific UL subband for the wireless communication device.

The wireless communication device may determine to use UE-specific UL subband when the cell-specific UL subband is not configured. In some embodiments, if a resource set C of the UE-specific UL subband is not configured, the wireless communication device may determine with the wireless communication node that the cell-specific UL subband uses a resource set C of the UE-specific UL subband of the wireless communication device. In some embodiments, if a resource set C of the UE-specific UL subband is not configured, the wireless communication device may determine with the wireless communication node that the cell-specific UL subband uses a resource set C of an UL bandwidth part (BWP) or an initial BWP of the wireless communication device.

Conversely, the wireless communication device may determine to use cell-specific UL subband when the UE-specific UL subband is not configured. In some embodiments, if symbol attribute parameters of the UE-specific UL subband is not configured, the wireless communication device may determine with the wireless communication node that the cell-specific UL subband uses symbol attribute parameters of the UE-specific UL subband of the wireless communication device. In some embodiments, if symbol attribute parameters of the UE-specific UL subband is not configured, the wireless communication device may determine with the wireless communication node that the cell-specific UL subband uses symbol attribute parameters of an UL bandwidth part (BWP) or an initial BWP of the wireless communication device.

The wireless communication device may carry out, perform, or execute a UL transmission using the UE-specific UL subband or the cell-specific UL subband, or both, of the wireless communication device to the wireless communication device (345). At least one of a resource set C or symbol attribute parameters of the cell-specific UL subband may be configured. At least one of: a resource set C or symbol attribute parameters of the UE-specific UL subband may be configured. The UL transmission may be scheduled or configured in resources of the UL subband for the wireless communication device. With this configuration, the wireless communication device may determine with the wireless communication node that the UL transmission is scheduled or configured in intersection of resources: of the cell-specific UL subband. the UE-specific UL subband and UL BWP resources of the wireless communication device, among others.

In some embodiments, the wireless communication device may determine with the wireless communication node that the UL transmission is executed based on at least one of symbol attribute parameters or a resource set C of the UE-specific UL subband. In some embodiments, the wireless communication device may determine with the wireless communication node that the UL transmission is executed based on at least one of symbol attribute parameters or a resource set C of a BWP of the wireless communication device. In some embodiments, the wireless communication device may determine with the wireless communication node that the wireless communication node indicates by signaling at least one of symbol attribute parameters or a resource set C used for the UL transmission.

When the resource type is for subband full-duplex (SBFD) slots, the wireless communication device may identify, configure, or determine a resource for a SBFD slot and a non-SBFD slot (350). The wireless communication device may configure the physical uplink shared channel (PUSCH) resource set for a SBFD slot or non-SBFD in accordance with a type of parameter in an UL grant. The parameter may be one of: parameter A or parameter B, among others. Upon receipt of the UL grant, the wireless communication device may process or parse the UL grant to extract or identify the parameter to use in configuring the resource for UL transmission.

In some embodiments, the wireless communication device may identify or determine a parameter A in an UL grant. The parameter A may identify or may be indicative of whether a physical uplink shared channel (PUSCH) resource allocation indicator in the UL grant is based on a PUSCH candidate resource set configured for a SBFD slot or on a PUSCH candidate resource set configured for a non-SBFD slot. The parameter A may identify or may be indicative of whether the UL grant itself is based on the PUSCH candidate resource set configured for the SBFD slot or on the PUSCH candidate resource set configured for the non-SBFD slot. The parameter A may identify or may be indicative of whether the UL grant itself is based on the SBFD slot or based on non-SBFD slot.

In some embodiments, the wireless communication device may identify or determine a parameter B in an UL grant. The parameter B may identify or may be indicative of whether a physical uplink shared channel (PUSCH) transmission scheduled in the UL grant is based on at least one of a subcarrier spacing or a cyclic prefix of the UL subband, or based on at least one of a subcarrier spacing or a cyclic prefix of an UL bandwidth part (BWP). The parameter B may identify or may be indicative of whether the UL grant itself is based on at least one of the subcarrier spacing or the cyclic prefix of the UL subband, or based on at least one of the subcarrier spacing or the cyclic prefix of the UL BWP. The parameter B may identify or may be indicative of whether the UL grant itself is based on the UL subband, or based on the UL BWP.

In some embodiments, the wireless communication may determine the resources to use in accordance with a set of tables received as part of the configuration from the wireless communication node. Each table may define a relationship between index of a PUSCH start symbol and a k2 value, with a length of PUSCH. With the receipt, the wireless communication device may determine the k2 value based on the index. Based on the determination, the wireless communication device may identify or determine a type of slot to use from the set of tables. The wireless communication device may identify or determine a PUSCH resource allocation indicator from the set of tables according to the type of slot.

In some embodiments, a first candidate set of PUSCH resources may be configured for slots not configured with UL subband via a first table (e.g., Table 6), and a second candidate set of PUSCH resources may be configured for slots configured with UL subband via a second table (e.g., Table 7). In some embodiments, k2 values may be included in a defined column in each of the first table and the second table. A respective k2 value in each row of the first table may be same as that in a corresponding row of the second table. A k2 value may represent a slot interval between a slot. The UL grant may be located and a slot where a corresponding physical uplink shared channel (PUSCH) transmission scheduled by the UL grant may be located. In some embodiments, each PUSCH resource in the first candidate set may be configured via information in at least one column and a respective row of the first table. In some embodiments, each PUSCH resource in the second candidate set may be configured via information in at least one column and a respective row of the second table.

In some embodiments, two PUSCH candidate resource sets may be configured for slots not configured with UL subband and slots configured with UL subband as the first table and the second table respectively. In some embodiments, the PUSCH resources may be configured as a column of the first table. In some embodiments, the k2 values may be configured as another column of the first table. The PUSCH resources may be configured as a column of the second table, and the k2 values are configured as another column of the second table. Each row of the first table and second table may contain one PUSCH resource and one k2 value respectively. The same row index in the first table and the second table may be configured with a same k2 value. In some embodiments, k2 may represent the slot interval between the slot where the UL grant is located and the slot where the PUSCH scheduled by the UL grant is located.

In some embodiments, the wireless communication device may determine the resources to use in accordance with a single table received as part of the configuration from the wireless communication node. The table may define a relationship between index of a PUSCH start symbol and a k2 value, with a length of PUSCH. With the receipt, the wireless communication device may determine the k2 value based on the index. Based on the determination, the wireless communication device may identify or determine a type of slot to use from the table. The wireless communication device may identify or determine a PUSCH resource allocation indicator from the set of tables according to the type of slot.

In some embodiments, a first candidate set of PUSCH resources may be configured for slots not configured with UL subband via a table, and a second candidate set of PUSCH resources may be configured for slots configured with UL subband via the table. In some embodiments, k2 values may be included in a defined column in the table. In some embodiments, a k2 value in each row of the table is associated with the PUSCH resource for slots not configured with UL subband and the PUSCH resource for slots configured with UL subband. In some embodiments, a k2 value may represent a slot interval between a slot where the UL grant is located and a slot where a corresponding physical uplink shared channel (PUSCH) transmission scheduled by the UL grant is located. In some embodiments, each PUSCH resource in the first candidate set may be configured via information in at least one column and a respective row of the table. In some embodiments, each PUSCH resource in the second candidate set may be configured via information in at least one other column and a respective row of the table.

In some embodiments, two PUSCH candidate resource sets may be simultaneously configured for slots not configured with UL subband and slots configured with UL subband in the third table. In some embodiments, the PUSCH resources for slots not configured with UL subband may be configured as a column of the third table, and the PUSCH resources for slots configured with UL subband may be configured as a column of the third table, and the k2 values may be configured as a column of the third table. In some embodiments, each row of the third table may contain one PUSCH resource for slots not configured with UL subband, one PUSCH resource for slots configured with UL subband, and one k2 value. In some embodiments, k2 represents the slot interval between the slot where the UL grant is located and the slot where the PUSCH scheduled by the UL grant is located.

With the determination, the wireless communication device may carry out, perform, or execute a UL transmission using the SBFD slot and the non-SBFD slot to the wireless communication node (355). The SBFD slot and the non-SBFD slot may be determined using Parameter A, Parameter B, or one or more tables, as detailed herein above. The wireless communication device may send the UL transmission within the SBFD slot and the non-SBFD slot to the wireless communication node.

The wireless communication node may retrieve, identify, or otherwise receive the UL transmission from the wireless communication device (360). When the configuration is for the resource of the cell-specific UL subband, the wireless communication node may wait for receipt of the UL transmission in the cell-specific UL subband from the wireless communication device. When the configuration is for the resource of the UE-specific UL subband, the wireless communication node may wait for receipt of the UL transmission in the UE-specific UL subband. When the configuration is for the resource of the UE-specific UL subband, the wireless communication node may wait for receipt of the UL transmission in the cell-specific UL subband or in the UE-specific UL subband. When the configuration is for the PUSCH resource for SBFD slot, the wireless communication node may wait for receipt of the UL transmission in the SBFD slot or non-SBFD slot, or both.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a wireless communication device from a wireless communication node, a configuration of resources for uplink (UL) transmission; and
determining, by the wireless communication device, at least one resource for an UL subband of the wireless communication device.

2. The method of claim 1, wherein resources of a cell-specific UL subband are configured by the configuration, and wherein (i) a resource set C refers to a candidate resource set, and (ii) symbol attribute parameters refer to at least one of a subcarrier spacing or a cyclic prefix.

3. The method of claim 2, wherein when the UL transmission is scheduled or configured in resources of the cell-specific UL subband for the wireless communication device:
if a resource set C of the cell-specific UL subband is not configured, the wireless communication device determines with the wireless communication node that the cell-specific UL subband uses a resource set C of an UL bandwidth part (BWP) or an initial BWP of the wireless communication device; and
if symbol attribute parameters of the cell-specific UL subband are not configured, the wireless communication device determines with the wireless communication node that the cell-specific UL subband uses symbol attribute parameters of the UL BWP or the initial BWP of the wireless communication device.

4. The method of claim 2, wherein when at least one of: a resource set C or symbol attribute parameters of the cell-specific UL subband are configured, and if the UL transmission is scheduled or configured in resources of the cell-specific UL subband for the wireless communication device, then the wireless communication device determines with the wireless communication node that:
the UL transmission is executed based on at least one of symbol attribute parameters or a resource set C:
(a) of an UL bandwidth part (BWP) of the wireless communication device; or
(b) indicated by signaling of the wireless communication node.

5. The method of claim 2, wherein when the cell-specific UL subband is configured in a downlink (DL) symbol or slot, and if the UL transmission is scheduled or configured in resources of the cell-specific UL subband for the wireless communication device, the UL transmission is executed based on symbol attribute parameters of a DL bandwidth part (BWP) of the wireless communication device or based on the symbol attribute parameters of an UL BWP of the wireless communication device.

6. The method of claim 2, wherein when the cell-specific UL subband is configured in a flexible symbol or slot, and if the UL transmission is scheduled or configured in resources of the cell-specific UL subband for the wireless communication device, the UL transmission is executed based on the symbol attribute parameters of an UL bandwidth part (BWP) of the wireless communication device or the UL transmission is executed based on symbol attribute parameters of a DL BWP of the wireless communication device.

7. The method of claim 2, wherein when the cell-specific UL subband is configured in a DL symbol or slot converted from a flexible symbol or slot, and if the UL transmission is scheduled or configured in resources of the cell-specific UL subband for the wireless communication device, then the UL transmission is executed based on symbol attribute parameters of a DL bandwidth part (BWP) of the wireless communication device or the UL transmission is executed based on symbol attribute parameters of an UL BWP of the wireless communication device.

8. The method of claim 1, wherein resources of a UE-specific UL subband are configured by the configuration, and wherein (i) a resource set C refers to a candidate resource set, and (ii) symbol attribute parameters refer to at least one of a subcarrier spacing or a cyclic prefix.

9. The method of claim 8, wherein when the UL transmission is scheduled or configured in resources of the UE-specific UL subband for the wireless communication device:
if a resource set C of the UE-specific UL subband is not configured, the wireless communication device determines with the wireless communication node that the UE-specific UL subband uses a resource set C of an UL bandwidth part (BWP) or an initial BWP of the wireless communication device; and
if symbol attribute parameters of the UE-specific UL subband are not configured, the wireless communication device determines with the wireless communication node that the UE-specific UL subband uses symbol attribute parameters of the UL BWP or the initial BWP of the wireless communication device.

10. The method of claim 8, wherein when at least one of: a resource set C or symbol attribute parameters of the UE-specific UL subband are configured, and if the UL transmission is scheduled or configured in resources of the UE-specific UL subband for the wireless communication device, then the wireless communication device determines with the wireless communication node that:
the UL transmission is executed based on at least one of symbol attribute parameters or a resource set C:
(a) of an UL bandwidth part (BWP) of the wireless communication device; or
(b) indicated by signaling of the wireless communication node.

11. The method of claim 8, wherein when the UE-specific UL subband is configured in a DL symbol or slot, and if the UL transmission is scheduled or configured in resources of the UE-specific UL subband for the wireless communication device, the UL transmission is executed based on symbol attribute parameters of a DL bandwidth part (BWP) of the wireless communication device or the UL transmission is executed based on symbol attribute parameters of an UL BWP of the wireless communication device.

12. The method of claim 8, wherein when the UE-specific UL subband is configured in a flexible symbol or slot, and if the UL transmission is scheduled or configured in resources of the UE-specific UL subband for the wireless communication device, the UL transmission is executed based on symbol attribute parameters of an UL bandwidth part (BWP) of the wireless communication device or the UL transmission is executed based on symbol attribute parameters of a DL BWP of the wireless communication device.

13. The method of claim 8, wherein when the UE-specific UL subband is configured in a DL symbol or slot converted from the flexible symbol or slot, and if the UL transmission is scheduled or configured in resources of the UE-specific UL subband for the wireless communication device, then the UL transmission is executed based on symbol attribute parameters of a DL bandwidth part (BWP) of the wireless communication device or the UL transmission is executed based on symbol attribute parameters of an UL BWP of the wireless communication device.

14. The method of claim 1, wherein resources of a cell-specific UL subband are configured by the configuration, resources of a UE-specific UL subband are also configured by the configuration, and wherein (i) a resource set C refers to a candidate resource set, and (ii) symbol attribute parameters refer to at least one of a subcarrier spacing or a cyclic prefix.

15. The method of claim 14, wherein:
when the UL transmission is scheduled or configured in resources of the cell-specific UL subband for the wireless communication device:
the wireless communication device determines with the wireless communication node that the cell-specific UL subband uses a resource set C of the UE-specific UL subband of the wireless communication device, or the cell-specific UL subband uses a resource set C of an UL bandwidth part (BWP) or an initial BWP of the wireless communication device if a resource set C of the UE-specific UL subband is not configured; and
the wireless communication device determines with the wireless communication node that the cell-specific UL subband uses symbol attribute parameters of the UE-specific UL subband of the wireless communication device; or the cell-specific UL subband uses symbol attribute parameters of an UL bandwidth part (BWP) or an initial BWP of the wireless communication device if symbol attribute parameters of the UE-specific UL subband is not configured.

16. The method of claim 14, wherein when at least one of: a resource set C or symbol attribute parameters of the cell-specific UL subband are configured, and at least one of: a resource set C or symbol attribute parameters of the UE-specific UL subband are configured, and if the UL transmission is scheduled or configured in resources of the UL subband for the wireless communication device, then the wireless communication device determines with the wireless communication node that:
the UL transmission is scheduled or configured in intersection resources of the cell-specific UL subband, the UE-specific UL subband and UL BWP resources of the wireless communication device, and that:
the UL transmission is executed based on at least one of symbol attribute parameters or a resource set C of the UE-specific UL subband; or
the UL transmission is executed based on at least one of symbol attribute parameters or a resource set C of a BWP of the wireless communication device; or
the wireless communication node indicates by signaling at least one of symbol attribute parameters or a resource set C used for the UL transmission.

17. The method of claim 1, comprising determining, by the wireless communication device, a parameter A in an UL grant, wherein the parameter A is indicative of:
whether a physical uplink shared channel (PUSCH) resource allocation indicator in the UL grant is based on a PUSCH candidate resource set configured for a SBFD slot or on a PUSCH candidate resource set configured for a non-SBFD slot; or
whether the UL grant itself is based on the PUSCH candidate resource set configured for the SBFD slot or on the PUSCH candidate resource set configured for the non-SBFD slot; or
whether the UL grant itself is based on the SBFD slot or based on non-SBFD slot.

18. A wireless communication device, comprising:
at least one processor configured to:
receive, via a receiver from a wireless communication node, a configuration of resources for uplink (UL) transmission; and
determine at least one resource for an UL subband of the wireless communication device.

19. A method, comprising:
sending, by a wireless communication node to a wireless communication device, a configuration of resources for uplink (UL) transmission,
wherein the wireless communication device determines at least one resource for an UL subband of the wireless communication device.

20. A wireless communication node, comprising:
at least one processor configured to:
send, via a transmitter to a wireless communication device, a configuration of resources for uplink (UL) transmission,
wherein the wireless communication device determines at least one resource for an UL subband of the wireless communication device.
